(19) United States
(12) Patent Application Publication
(10) Pub. No.: US 2024/0053467 A1
(43) Pub. Date: Feb. 15, 2024

(54) RADAR APPARATUS, SYSTEM, AND METHOD

(71) Applicant: Intel Corporation, Santa Clara, CA (US)

(72) Inventors: Nir Dvorecki, Herzeliya (IL); Yuval Amizur, Kfar-Saba (IL); Leor Banin, Petach Tikva (IL)

(73) Assignee: Intel Corporation, Santa Clara, CA (US)

(21) Appl. No.: 18/260,569

(22) PCT Filed: Feb. 7, 2021
(86) PCT No.: PCT/US2021/016983

§ 371 Date: Jul. 6, 2023

(51) Int. Cl. G01S 13/87; G01S 7/35; G01S 7/41

(52) U.S. Cl. CPC G01S 13/87; G01S 7/356; G01S 7/411; G01S 2013/93271

(57) ABSTRACT

Some demonstrative aspects include radar apparatuses, devices, systems and methods. In one example, an apparatus may include one or more Transmit (Tx) antennas to transmit radar Tx signals, one or more Receive (Rx) antennas to receive radar Rx signals, and a processor to generate radar information based on the radar Rx signals. The apparatus may be implemented, for example, as part of a radar device, for example, as part of a vehicle including the radar device. In other aspects, the apparatus may include any other additional or alternative elements and/or may be implemented as part of any other device.

### TECHNICAL FIELD

Aspects described herein generally relate to radar devices.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LIDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of a radar frontend and a radar processor, in accordance with some demonstrative aspects.

FIG. 9 is a schematic illustration of elements of a radar device including a plurality of radars, in accordance with some demonstrative aspects, in accordance with some demonstrative aspects.

FIG. 10 is a schematic illustration of a radar detection scheme, in accordance with some demonstrative aspects.

FIG. 11 is a schematic illustration of a radar detection scheme, in accordance with some demonstrative aspects.

FIG. 12 is a schematic illustration of a radar detection scheme, in accordance with some demonstrative aspects.

FIG. 13 is a schematic illustration of a radar detection scheme, in accordance with some demonstrative aspects.

FIG. 14 is a schematic flow-chart illustration of a method of generating radar information based on radar synchronization information to synchronize between first and second radars, in accordance with some demonstrative aspects.

FIG. 15 is a schematic illustration of elements of a radar device including a plurality of radar front-ends, in accordance with some demonstrative aspects.

FIG. 16 is a schematic illustration of timing diagrams corresponding to radar signals communicated between radar front-ends, in accordance with some demonstrative aspects.

FIG. 17 is a schematic illustration of a deployment of a first radar front-end and a second radar front-end in a vehicle.

FIG. 18 is a schematic flow-chart illustration of a method of synchronizing between a plurality of radar front-ends, in accordance with some demonstrative aspects.

FIG. 19 is a schematic illustration of a method of radar processing based on a non-periodic Tx radar signal, in accordance with some demonstrative aspects.

FIG. 20 is a schematic illustration of a method of radar processing based on a non-periodic Tx radar signal having a non-periodic pattern, in accordance with some demonstrative aspects.

FIG. 21 is a schematic illustration of a method of radar processing based on Tx radar signals transmitted via a plurality of Tx antennas according to a non-periodic mapping scheme, in accordance with some demonstrative aspects.

FIG. 22 is a schematic illustration of a radar radome apparatus configured to protect a radar antenna, in accordance with some demonstrative aspects.

FIG. 23 is a schematic illustration of a cross section view of a radar radome apparatus, and an exploded view of the radar radome apparatus, in accordance with some demonstrative aspects.

FIG. 24 is a schematic illustration of an exploded view of a polymeric conductive layer to protect a radar antenna, in accordance with some demonstrative aspects.

FIG. 25 is a schematic illustration of a radar radome apparatus, in accordance with some demonstrative aspects.

FIG. 26 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, embodiment, or design described herein as “exemplary” or “demonstrative” is not necessarily to be construed as preferred or advantageous over other aspects, embodiments, or designs.

References to “one embodiment”, “an embodiment”, “demonstrative embodiment”, “various embodiments” “one aspect”, “an aspect”, “demonstrative aspect”, “various aspects” etc., indicate that the embodiment(s) and/or aspects so described may include a particular feature, structure, or characteristic, but not every embodiment or aspect necessarily includes the particular feature, structure, or characteristic. Further, repeated use of the phrase “in one embodiment” or “in one aspect” does not necessarily refer to the same embodiment or aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

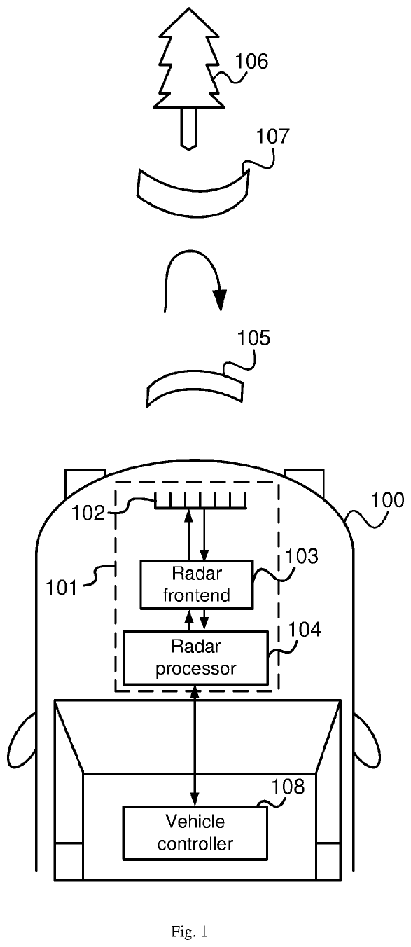

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, a driver assistance and/or support system, and/or the like.

For example, radar device 101 may be installed in vehicle 101 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below. In one example, radar device 101 may be mounted onto, placed, e.g., directly, onto, or attached to, vehicle 100.

In some demonstrative aspects, vehicle 100 may include a single radar device 101. In other aspects, vehicle 100 may include a plurality of radar devices 101, for example, at a plurality of locations, e.g., around vehicle 100.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

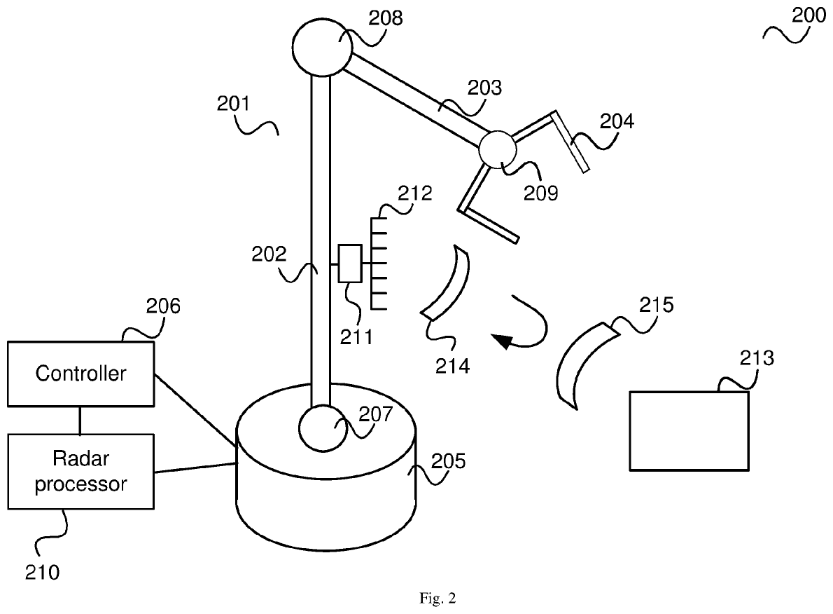

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

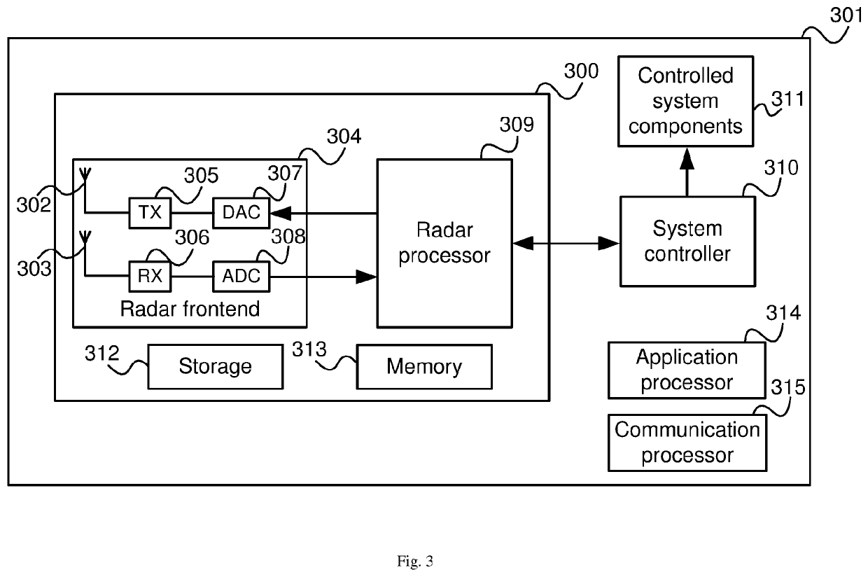

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital (ADC) Converter 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

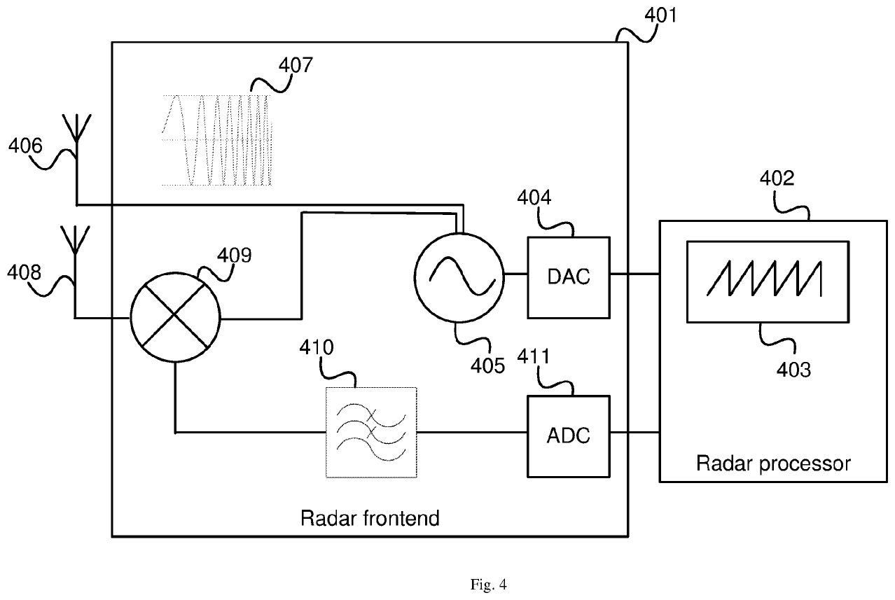

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

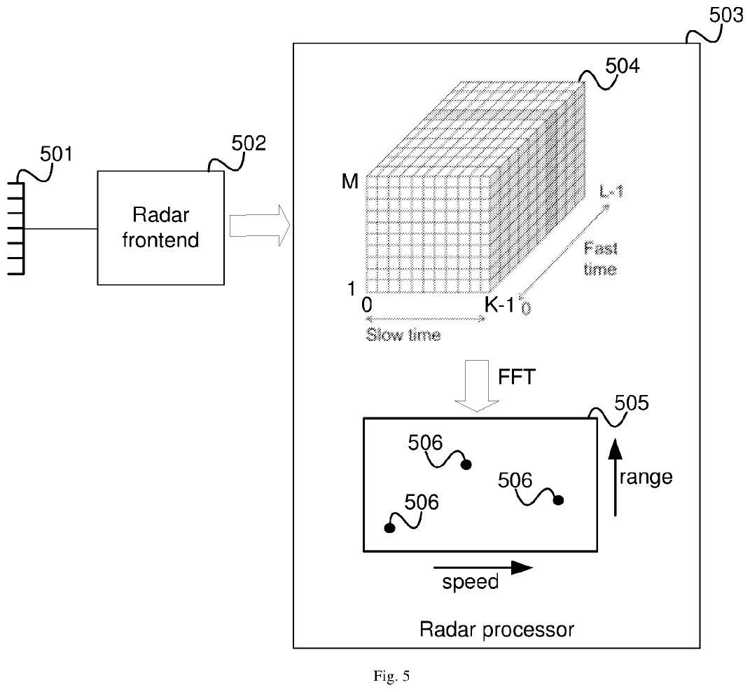

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 105 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

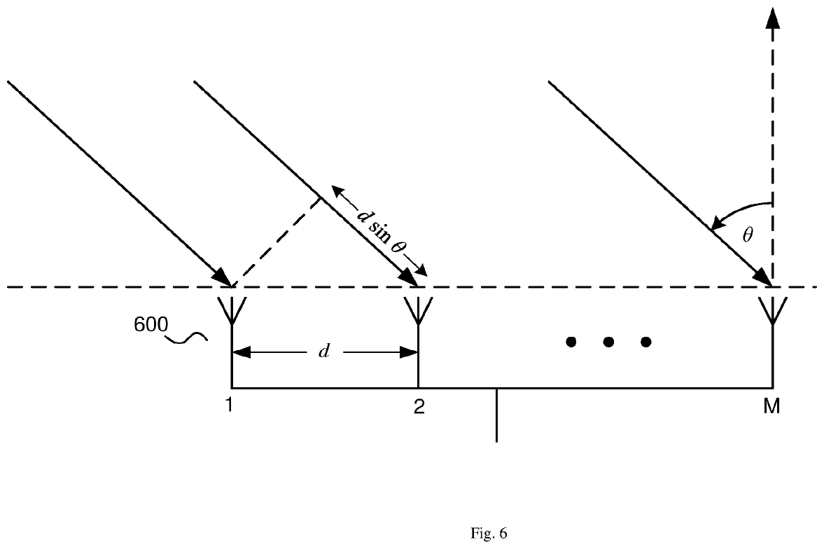

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 601 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

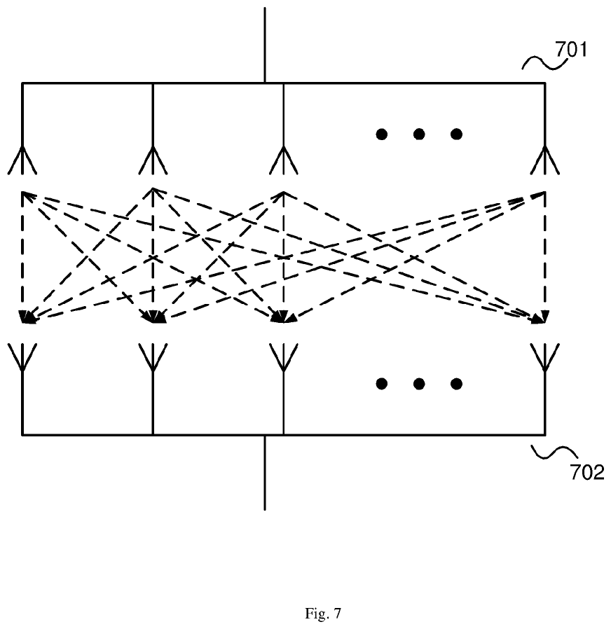

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

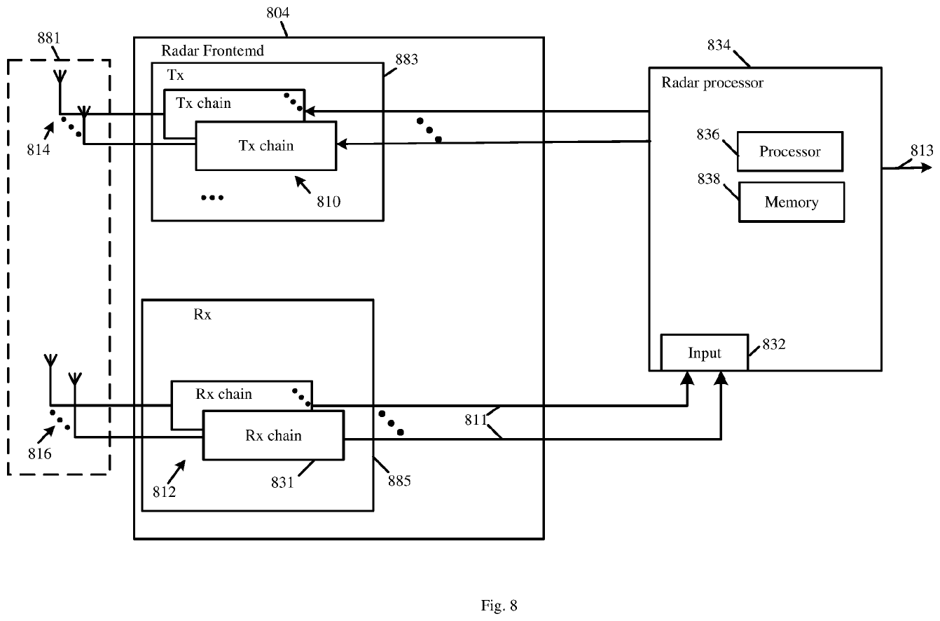

FIG. 8 is a schematic block diagram illustration of a radar frontend 804 and a radar processor 834, in accordance with some demonstrative aspects. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 1), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on Radar Rx data 811 received from the plurality of Rx chains 812. For example, radar Rx data 811 may be based on the Rx RF signals received via the Rx antennas 816.

In some demonstrative aspects, radar processor 834 may include an input 832 to receive the radar Rx data 811 from the plurality of Rx chains 812.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which maybe generated by processor 836, for example, based on the radar Rx data, e.g., as described below. In one example, the range information and/or Doppler information may be determined based on a Cross-Correlation (XCORR) operation, which may be applied to the radar RX data, e.g., as described below. Any other additional or alternative operation, algorithm and/or procedure may be utilized to generate the range information and/or Doppler information.

In some demonstrative aspects, memory 838 may be configured to store AoA information, which maybe generated by processor 836, for example, based on the radar Rx data, the range information and/or Doppler information, e.g., as described below. In one example, the AoA information may be determined based on an AoA estimation algorithm, e.g., as described below. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information, e.g., as described below.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via a Tx array including a plurality of N elements, e.g., Tx antennas 814, and processing received signals via an Rx array including a plurality of M elements, e.g., Rx antennas 816.

In some demonstrative aspects, utilizing the MIMO technique of transmission of the orthogonal signals from the Tx array with N elements and processing the received signals in the Rx array with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a system for example, a vehicle, e.g., vehicle 100 (FIG. 1), or any other system, may include a plurality of radars, for example, a plurality of radar frontends 804, e.g., as described below.

In some demonstrative aspects, the plurality of radar front ends 804 may be configured to cover a respective plurality of Field of Views (FOVs), e.g., as described below.

In one example, the plurality of front ends 804 may be implemented, for example, such that a combination of FOVs of the plurality of radar frontends 804 may cover a FOV of about 360 degrees around the vehicle, e.g., vehicle 100 (FIG. 1). In other aspects, the plurality of radar frontends may be configured to cover any other FOV, e.g., less than 360 degrees.

In some demonstrative aspects, the plurality of radar frontends 804 may be implemented as high-resolution radars, which may operate in the 76-81 GHz band or any other frequency band, for example, to support an Autonomous Vehicle (AV) functionality, e.g., of vehicle 100.

In one example, at least 6 radars may be utilized, for example, to provide a 360 degrees FOV for the AV. In other aspects, any other number for radars may be used.

In some demonstrative aspects, radar processor 834 may be configured to process radar Rx data 811 from a plurality of radars, for example, from a plurality of radar frontends 804, e.g., as described below.

In some demonstrative aspects, there may be a need to address one or more technical issues, for example, when processing data from a plurality of radars, e.g., as described below.

In one example, implementation of the plurality of radars may result in mutual interferences between radar signals communicated by the plurality of radars.

In some demonstrative aspects, there may be a need to provide a technical solution for efficiently synchronizing between radars of the plurality of radars, for example, in order to mitigate effects of the mutual interferences between radar signals communicated by the plurality of radars.

In some demonstrative aspects, radar processor 834 may be configured to process the radar Rx data 811 from the plurality of radars, for example, based on radar synchronization information, which may synchronize between the plurality of radars, e.g., as described below.

In some demonstrative aspects, radar processor 834 may be configured to synchronize between the plurality of radars according to synchronization mechanism, which may be based on communications performed by the plurality of radars, e.g., as described below.

In some demonstrative aspects, the synchronization mechanism may be configured, for example, to provide a radar system having improved accuracy, reliability, and/or spoofing resilience, e.g., as described below.

In some demonstrative aspects, radar processor 834 may be configured to synchronize between the plurality of radars according to the synchronization mechanism, for example, even without implementing cables to connect between the plurality of radars, e.g., as described below.

In some demonstrative aspects, radar processor 834 and/or the plurality of radars, e.g., the plurality of radar frontends 804 may be configured to implement and/or support a coordination scheme including a broadcast protocol, which may enable sharing of information between the plurality of radars, for example, through over-the-air synchronization messages, e.g., as described below.

In some demonstrative aspects, the coordination scheme may be utilized by the radar processor 834 to harness the interferences between the plurality of radars, for example, in order to improve an accuracy and/or a reliability of the radar solution, e.g., as described below.

In some demonstrative aspects, a radar solution utilizing transmissions of the plurality of radars, e.g., as described herein may provide a technical solution with improved resilience to spoofing, e.g., as transmissions from one radar may be combined with transmissions from one or more other radars, e.g., as described below.

In some demonstrative aspects, a radar solution utilizing the transmissions of the plurality of radars for synchronizing between the radars, e.g., as described herein, may provide a technical advantage, for example, compared to a solution utilizing cables to connect between the radars. In one example, using cables to transfer information for synchronization between radars may be cumbersome, expensive and even technically impossible in some cases. For example, installation of the cables on a vehicle may prevent a one-by-one radar installation on the vehicle as an “out-of-the-box” product. Additionally, the installation of the cables may not make full use of an accuracy, which may be provided by the one-by-one radar installation on the vehicle.

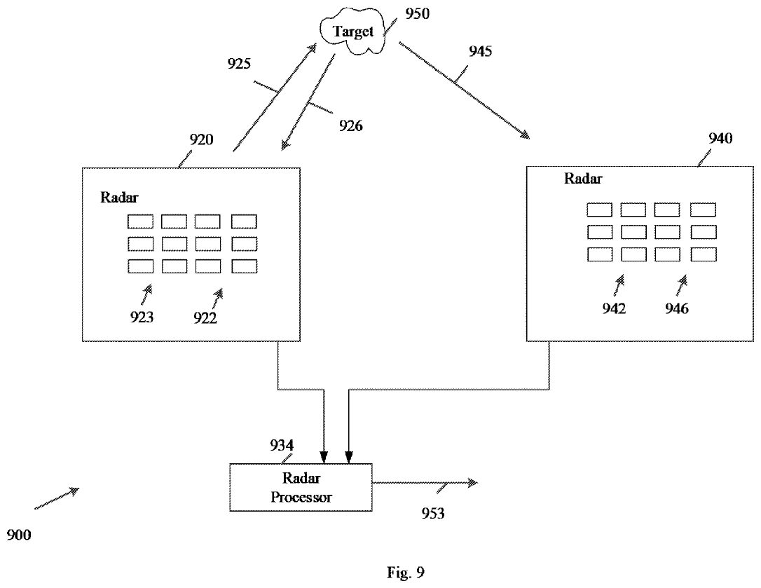

Reference is made to FIG. 9, which schematically illustrates elements of a radar device 900 including a plurality of radars, in accordance with some demonstrative aspects. For example, radar device 101 (FIG. 1), may include one or more elements of radar device 900, and/or may perform one or more operations and/or functionalities of radar device 900.

In some demonstrative aspects, radar device 900 may include a plurality of radars, for example, including a first radar 920 and a second radar 940. For example, radar 920 may include one or more elements of, and/or may perform one or more operations and/or functionalities of, a first radar front-end 804 (FIG. 8); and/or radar 940 may include one or more elements of, and/or may perform one or more operations and/or functionalities of, a second radar front-end 804 (FIG. 8).

In some demonstrative aspects, the plurality of radars may include at least 6 radars, for example, including the first radar 920 and second radar 940.

In other aspects, the plurality of radars may include any other number of radars, e.g., less than 6 radars or more than 6 radars.

In some demonstrative aspects, the plurality of radars may be configured and/or positioned to cover a respective plurality of FOVs, e.g., as described below.

In some demonstrative aspects, a combination of the plurality of FOVs may cover a FOV of about 360 degrees, or any other FOV, around a vehicle, e.g., vehicle 100 (FIG. 1).

In some demonstrative aspects, radar 920 may include a first plurality of Transmit (Tx) antennas 922 and a first plurality of Receive (Rx) antennas 923, e.g., as described below.

In some demonstrative aspects, radar 920 may be configured to communicate radar signals in a first radar FOV e.g., as described below.

In some demonstrative aspects, radar 940 may include a second plurality of Tx antennas 942 and a second plurality of Rx antennas 946, e.g., as described below.

In some demonstrative aspects, the second radar 940 may be configured to communicate radar signals in a second radar FOV, e.g., as described below.

In some demonstrative aspects, the first and second radar FOVs may partially overlap. For example, the first and second radar FOVs may both cover an overlapping FOV, e.g., as described below.

In some demonstrative aspects, radar device 900 may include a radar processor 934 configured to determine radar synchronization information to synchronize between the first radar 920 and the second radar 940. For example, radar processor 834 (FIG. 8) may include one or more elements of radar processor 934, and/or may perform one or more operations and/or functionalities of radar processor 934.

In some demonstrative aspects, radar processor 934 may be configured to generate radar information 953 corresponding to a target 950, for example, based at least on the radar synchronization information, a Tx radar signal 925 transmitted by the first radar 920, a first Rx signal 926 received by the first radar 920 based on the Tx radar signal 925, and a second Rx signal 945 received by the second radar 940 based on the Tx signal 925, e.g., as described below.

In some demonstrative aspects, radar processor 934 may be configured to determine the radar synchronization information to synchronize between the first radar 920 and the second radar 940, for example, at an accuracy of up to 1 nanosecond, e.g., as described below. In other aspects, any other level of accuracy may be achieved.

In some demonstrative aspects, radar processor 934 may be configured to determine the radar synchronization information, for example, based on timing information broadcasted via the first radar 920 and received via the second radar 940, e.g., as described below.

In some demonstrative aspects, radar processor 934 may be configured to determine the radar information 953 corresponding to the target 950, for example, based on shared radar information, which may be broadcasted via the first radar 920 and received via the second radar 940, e.g., as described below.

In some demonstrative aspects, radar processor 934 may be configured to determine the radar information 953 corresponding to the target 950, for example, based on a plurality of Radar Cross Section (RCS) estimations corresponding to the signals communicated by the radars 920 and/or 940, e.g., as described below.

In some demonstrative aspects, the plurality of RCS estimations may include a first RCS estimation and a second RCS estimation, e.g., as described below.

In some demonstrative aspects, the first RCS estimation may be based, for example, on the Tx radar signal 925 transmitted by the first radar 920, and the first Rx signal 926 received by the first radar 920 based on the Tx signal 925, e.g., as described below.

In some demonstrative aspects, the second RCS estimation may be based, for example, on the Tx radar signal 925 transmitted by the first radar 920, and the second Rx signal 945 received by the second radar 940 based on the Tx signal 925, e.g., as described below.

In some demonstrative aspects, the plurality of RCS estimations may include a third RCS estimation and a fourth RCS estimation, e.g., as described below.

In some demonstrative aspects, the third RCS estimation may be based on an other Tx signal transmitted by the second radar 940 and a third Rx signal received by the second radar 940 based on the other Tx signal, e.g., as described below.

In some demonstrative aspects, the fourth RCS estimation may be based on the other Tx signal transmitted by the second radar 940 and a fourth Rx signal received by the first radar 920 based on the other Tx signal, e.g., as described below.

In one example, an RCS of a target, e.g., target 950, may represent an energy dispersed back from the target towards a radar device, e.g., radar devices 920 and/or 940.

In some demonstrative aspects, the RCS of the target may vary, e.g., significantly, even for small changes of a Tx angle from a radar transmitter of radar signal to the target, and/or an Rx angle of the radar signal at a radar receiver.

In some demonstrative aspects, radar processor 934 may be configured to control a radar device of radar devices 920 and/or 940 to transmit a Tx radar signal, and to control both radar devices 920 and 940 to receive Rx signals based on the Tx radar signals.

In some demonstrative aspects, radar processor 934 may measure RCS s of a target, e.g., target 950, which is in an overlap region, for example, using Rx signals received from the same target at both radar devices 920 and 940.

In some demonstrative aspects, the Rx signals may be received at both radar devices 920 and 940 using two slightly different Rx angles, which may generate RCS diversity, and, therefore, may increase an effective SNR of radar information determined by radar device 920.

In some demonstrative aspects, the RCS diversity may be achieved, for example, based on radar signals communicated via a plurality of paths, for example, 4 paths, e.g., as described below.

Some demonstrative aspects are described herein with respect to RCS diversity based on 4 radar paths defined with respect to two radars, e.g., as described below. In other aspects, RCS diversity may be achieved based on any other number of radar paths. In one example, RCS diversity may be achieved based on more than 4 radar paths, for example, when utilizing three or more radars having overlap of FOVs.

In some demonstrative aspects, a first path may include a path from a first radar device to a target, and back from the target to the first radar device. For example, the first path may include a path from radar device 920 to target 950, and back from target 950 to radar device 920. For example, the first RCS estimation may be based on the first path.

In some demonstrative aspects, a second path may include a path from the first radar device to the target, and back from the target to a second radar device. For example, the second path may include a path from radar device 920 to target 950, and back from target 950 to radar device 940. For example, the second RCS estimation may be based on the second path.

In some demonstrative aspects, a third path may include a path from the second radar device to the target, and back from the target to the second radar device. For example, the third path may include a path from radar device 940 to target 950, and back from target 950 to radar device 940. For example, the third RCS estimation may be based on the third path.

In some demonstrative aspects, a fourth path may include a path from the second radar device to the target, and back from the target to the first radar device. For example, the fourth path may include a path from radar device 940 to target 950, and back from target 950 to radar device 920. For example, the fourth RCS estimation may be based on the fourth path.

In some demonstrative aspects, the plurality of paths may have different properties, for example, as a result different structures of Rx and/or Tx arrays corresponding to each of the paths, and/or due to an effect of different surfaces and/or nearby scatterers on the signals propagating via the different paths.

In some demonstrative aspects, the different properties of the plurality of paths may result in different RCS estimations, e.g., including a first RCS for a first path, and a second RCS, different from the first RCS, for a second path.

In some demonstrative aspects, radar processor 934 may be configured to determine the radar information 953 corresponding to the target 950, for example, according to a super-resolution algorithm, for example, based on a plurality of snapshots, e.g., as described below.

In some demonstrative aspects, the plurality of snapshots may include a first snapshot and a second snapshot, e.g., as described below.

In some demonstrative aspects, the first snapshot may be based on the Tx radar signal 925 transmitted by the first radar 920 and the first Rx signal 926 received by the first radar 920 based on the Tx radar signal 925, e.g., as described below.

In some demonstrative aspects, the second snapshot may be based on the Tx radar signal 925 transmitted by the first radar 920 and the second Rx signal 945 received by the second radar 940 based on the Tx radar signal 925, e.g., as described below.

In some demonstrative aspects, the plurality of snapshots may be utilized, for example, to improve a correlation matrix for the super resolution algorithm, e.g., as described below.

In some demonstrative aspects, radar processor 934 may be configured to perform the super resolution algorithm, for example, using the plurality of snapshots received from radar devices 920 and 940 with respect to a same transmission, e.g., transmission of Tx radar signal 925.

In one example, radar devices 920 and 940 may not be phase-synchronized, and/or their exact location and/or an exact target location, e.g., an exact location of target 950, may not be known, e.g., at a millimeter accuracy. For example, there may be a random phase difference between radar devices 920 and 940. Accordingly, signals communicated between radar devices 920 and 940 may not be processed as signals of a single MIMO radar, for example, without taking into consideration random phase difference.

In some demonstrative aspects, radar processor 934 may use the plurality of snapshots, e.g., including the first and second snapshots described above, as snapshots which measure one or more same targets, e.g., target 950, and which include a superposition of signals from the same targets, for example, with different random phases from each target to each of the radars.

In some demonstrative aspects, radar processor 934 may be configured to use the plurality of snapshots, e.g., including the first and second snapshots described above, as input snapshots for a super resolution algorithm, e.g., a MUSIC algorithm, a Capon algorithm, an Iterative Adaptive Approach (IAA) algorithm, and/or any other super resolution algorithm.

For example, radar processor 934 may be configured to determine the first snapshot based on the Tx radar signal 925 transmitted by the first radar 920 and the first Rx signal 926 received by the first radar 920 based on the Tx radar signal 925; to determine the second snapshot based on the Tx radar signal 925 transmitted by the first radar 920 and the second Rx signal 945 received by the second radar 940 based on the Tx radar signal 925; and to apply a super-resolution algorithm to the first and second snapshots, for example, to determine AOA information, e.g., azimuth AoA and/or elevation AoA information, with improved resolution, for example, with respect to targets located in the overlap region of radars 920 and 940, e.g., target 950.

In some demonstrative aspects, radar processor 934 may be configured to identify a ghost target in a multipath scenario, for example, based on the signals communicated by radars 920 and 940, e.g., as described below.

In some demonstrative aspects, radar processor 934 may identify the ghost target in the multipath scenario, for example, based on the second Rx signal 945, e.g., received by the second radar 940.

In one example, a multipath scenario may include multipath signals from a plurality of paths between a radar and a target. For example, the multipath scenario may include a plurality of paths between radar 920 and target 950, and/or a plurality of paths between radar 940 and target 950.

In some demonstrative aspects, radar processor 934 may be configured to generate the radar information 953, for example, based on identification of the ghost target, e.g., as described below.

In some demonstrative aspects, radar processor 934 may be configured to identify the ghost target, for example, based on detecting an appearance of the ghost target in a first radar path and detecting disappearance of the ghost target in a second radar path, e.g., as described below.

In some demonstrative aspects, radar processor 934 may be configured to identify the ghost target, for example, in a first multipath scenario, e.g., as described below.

In some demonstrative aspects, the first radar path, e.g., in the first multipath scenario, may include the Tx signal 925 from the first radar 920 and the second Rx signal 945, e.g., received by the second radar 940 based on the TX signal 925.

In some demonstrative aspects, the second radar path, e.g., in the first multipath scenario, may include another Tx signal from the second radar 940 and an other Rx signal received by the first radar 920, for example, based on the other Tx signal from the second radar 940, e.g., as described below.

In some demonstrative aspects, radar processor 934 may be configured to identify the ghost target, for example, in a second multipath scenario, e.g., as described below.

In some demonstrative aspects, the first radar path, e.g., in the second multipath scenario, may include a first Tx signal from the first radar 920 to a first target, a first scattered signal from the first target, a first reflected signal reflected from a second target back to the first target, and a second reflected signal reflected back from the first target to the first radar 920, e.g., as described below.

In some demonstrative aspects, the second radar path e.g., in the second multipath scenario, may include a second Tx signal from the second radar 940 to the second target, a second scattered signal from the second target, a third reflected signal reflected from the first target back to the second target, and a fourth reflected signal reflected back from the second target to the second radar 940, e.g., as described below.

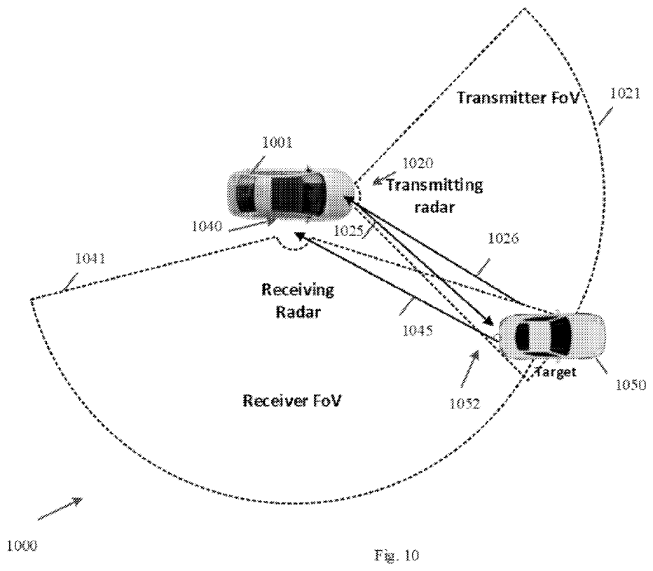

Reference is made to FIG. 10, which schematically illustrates a radar detection scheme 1000, in accordance with some demonstrative aspects.

In some demonstrative aspects, as shown in FIG. 10, a vehicle 1001 may include a first radar 1020 and a second radar 1040. For example, vehicle 1001 may include one or more elements of vehicle 100 (FIG. 1) and/or may perform one or more operations and/or functionalities of vehicle 100 (FIG. 1); first radar 1020 may include one or more elements of first radar 920 (FIG. 9), and/or may perform one or more operations and/or functionalities of first radar 920 (FIG. 9); and/or second radar 1040 may include one or more elements of second radar 940 (FIG. 9), and/or may perform one or more operations and/or functionalities of second radar 940 (FIG. 9).

In some demonstrative aspects, as shown in FIG. 10, radar 1020 may be configured to communicate radar signals in a first radar FOV 1021.

In some demonstrative aspects, as shown in FIG. 10, second radar 1040 may be configured to communicate radar signals in a second radar FOV 1041.

In some demonstrative aspects, as shown in FIG. 10, the first FOV 1021 and second radar FOV 1041 may partially overlap, e.g., in an overlapping FOV region 1052.

In some demonstrative aspects, as shown in FIG. 10, a target 950 may be located in the overlapping FOV region 1052.

In some demonstrative aspects, radar processor 934 (FIG. 9) may be configured to generate radar information 953 (FIG. 9) corresponding to target 1050, for example, based on a Tx radar signal 1025 transmitted by the first radar 1020, a first Rx signal 1026 received by the first radar based on the Tx signal 1025, and a second Rx signal 1045 received by the second radar 1040 based on the Tx signal 1025.

In some demonstrative aspects, as shown in FIG. 10, radar device 1040 may listen not only to the back-scattered pulses resulting from its own transmissions, but also to transmissions and back-scattered pulses coming from other radars, e.g., radar 1020. For example, radar device 1040 may listen to transmissions and/or back-scattered pulses coming from radar device 1020, e.g., signals resulting from the Tx radar signal 1025 from radar 1020.

In some demonstrative aspects, radar devices 1020 and 1040, may be configured to share information between the radar devices 1020 and 1040, for example, according to a Coordinated-Radar (CoRD) mechanism, e.g., as described below.

In one example, the CoRD mechanism may be implemented, for example, according to the mechanism described in “Accurate Time Synchronization for Automotive Cooperative Radar (CoRD) Applications”, O. Bar-Shalom, N. Dvorecki, L. Banin, E Amizur-2020 IEEE International Radar Conference (RADAR).

In other aspects radar devices 1020 and 1040 may utilize any other additional or alternative protocol, e.g., wireless and/or wired protocol, to share information between the radar devices 1020 and 1040.

In some demonstrative aspects, the shared information may include identification information, e.g., as described below.

In some demonstrative aspects, the shared information may include location, position, and/or angular information, e.g., as described below.

In some demonstrative aspects, a radar device, e.g., radar device 1020, may broadcast information about its own transmissions, for example, to enable other radar devices, e.g., radar 1040, to utilize the transmissions, e.g., as described below.

In one example, the radar device, e.g., radar device 1020, may be configured to broadcast a device identification (ID) of the radar device, for example, to enable other radar devices, e.g., radar device 1040, to extract angular information of each of its neighbor devices. For example, the angular information may be compared to a radar detect image, for example, to validate targets.

In other aspects, the shared information may include any other information.

In some demonstrative aspects, radar processor 934 (FIG. 9) may be configured to detect whether a target is real, for example, not a result of a multi-path, e.g., a ghost target. For example, radar processor 934 (FIG. 9) may be aware that there is only a certain portion of FOV overlap between each two radars, e.g., overlapping FOV region 1052. Accordingly, radar processor 934 (FIG. 9) may be configured to process information of a receiving radar device, e.g., radar device 1040, to detect, e.g., with high certainty, that a target detected from the transmissions of neighbors of the receiving radar device, e.g., radar device 1020, is a real target in the overlap region 1052, and not a ghost target resulting from multi-path signals. For example, this detection may be similar to performing transmit beamforming to the overlap region 1052.

In some demonstrative aspects, radar devices 1020 and 1040, may be configured to share timing information between the radar devices, e.g., as described below.

In one example, sharing the timing information between the radar devices may enable sub-nanosecond synchronization between the radar devices.

In some demonstrative aspects, the timing information may enable a radar device, e.g., radar device 1040, to localize targets in the overlapping FOV 1052, e.g., target 1050, for example, using transmissions from the neighboring radars, e.g., using Tx radar signal 1025 transmitted by the first radar 1020.

In some demonstrative aspects, the phase offset between the radar devices 1020 and 1040 may be considered to be random, e.g., a function of minor fluctuations in the position of the devices, which may result from vibrations and the like. Accordingly, radar processor 934 (FIG. 9) may utilize the shared timing information to detect targets with an improved angular resolution,

In some demonstrative aspects, radar devices 1020 and 1040 may be configured to share radar data between the radar devices, e.g., as described below.

In some demonstrative aspects, radar devices 1020 and 1040 may share, for example, Doppler, e.g., velocity, information between the radar devices, e.g., as described below.

In some demonstrative aspects, a radar device, e.g., radar device 1020, may transfer velocity information to its neighbors, for example, to allow a neighbor radar device, e.g., radar device 1040, to accurately estimate a speed of a target, e.g., target 1050, for example, even if the neighbor radar device cannot estimate the speed, for example, due to a geometry of vehicle 1001, a capability of the neighbor radar device, and/or any other reason.

In some demonstrative aspects, the radar device, e.g., radar device 1020, may transfer the velocity information to its neighbors, for example, to support an improved speed estimate of a target, e.g., target 1050, for example, by combining speed estimates of the speed, e.g., from the radar device and from the neighbor radar device, for example, to reduce an overall error of the speed estimate.

In some demonstrative aspects, radar devices 1020 and/or 1040 may be configured to receive and decode signal transmitted by their neighbor radar devices.

In some demonstrative aspects, radar devices 1020 and/or 1040 may include one or more hardware components of a communication system, for example, a signal acquisition module, encoders, decoders, and/or any other additional or alternative components and/or elements, which may support reception and/or decoding of information received from the neighbor radar devices.

In some demonstrative aspects, one or more attributes of a transmitted radar signal may be modified, and/or one or more attributes may be added, for example, to assist other radar devices in receiving and/or decoding the transmitted radar signal.

In some demonstrative aspects, a modulation of transmitted signals, e.g., Tx radar signal 1025, may be changed or modified, for example, to assist other radar devices to receive the transmitted signals.

In one example, the transmitted signal may include a preamble, which may support time synchronization.

In one example, the transmitted signal may include any other additional or alternative information, for example, to support information sharing between the radar devices.

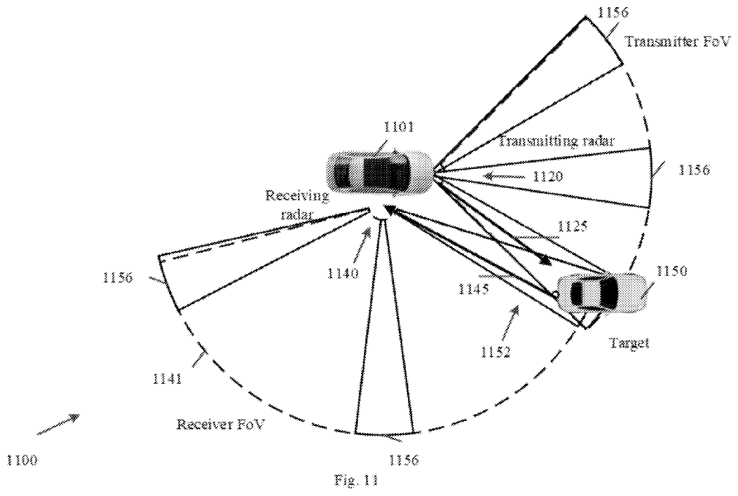

Reference is made to FIG. 11, which schematically illustrates a radar detection scheme 1100, in accordance with some demonstrative aspects.

In some demonstrative aspects, as shown in FIG. 11, a vehicle 1101 may include a first radar 1120 and a second radar 1140. For example, vehicle 1101 may include one or more elements of vehicle 100 (FIG. 1), and/or may perform one or more operations and/or functionalities of vehicle 100 (FIG. 1); first radar 1120 may include one or more elements of first radar 920 (FIG. 9), and/or may perform one or more operations and/or functionalities of first radar 920 (FIG. 9); and/or second radar 1140 may include one or more elements of second radar 940 (FIG. 9), and/or may perform one or more operations and/or functionalities of second radar 940 (FIG. 9).

In some demonstrative aspects, as shown in FIG. 11, radar 1120 may be configured to transmit radar signals 1125 in a first radar FOV 1121.

In some demonstrative aspects, as shown in FIG. 11, second radar 1140 may be configured to receive radar signals 1145 in a second radar FOV 1141.

In some demonstrative aspects, as shown in FIG. 11, the first FOV 1121 and second radar FOV 1141 may partially overlap, e.g., in an overlapping region 1152, e.g., as described below.

In some demonstrative aspects, as shown in FIG. 11, a target 1150 may be located in the overlapping FOV region 1152.

In some demonstrative aspects, radar processor 934 (FIG. 9) may be configured to generate radar information 1153 (FIG. 9), corresponding to target 1150, for example, based on the Tx radar signals 1125 transmitted by the first radar 1120, and the Rx signals 1145 received by the second radar 1140 based on the Tx signals 1125.

In some demonstrative aspects, radar processor 934 (FIG. 9) may be configured to mitigate grating lobes in an AoA spectrum, which may be determined, for example, based on the Tx radar signals 1125 transmitted by the first radar 1120, and the Rx signals 1145 received by the second radar 1140, e.g., as described below.

In one example, the grating lobes may represent ambiguities of target angles, for example, which may appear, for example, when using an antenna array in which a distance between the antennas is larger than half-wavelength of the Tx radar signals. Such an antenna may provide improved resolution, for example, at the cost of the resulting grating lobes.

In some demonstrative aspects, when processing radar signals, which are based on radar Tx signals transmitted by a first radar device, e.g., Tx radar signals 1125 transmitted by radar device 920, and radar Rx signals received by a second radar device, e.g., Rx radar signals 1145 received by radar device 1145, grating lobes outside of the overlapping FOV region 1152 may be attenuated significantly, e.g., according to the antenna pattern of the radar devices.

In some demonstrative aspects, this phenomena of attenuating the grating lobes may be utilized, for example, to provide a technical solution of utilizing an antenna array in which a distance between the antennas is larger than half-wavelength of the Tx radar signals, while to mitigate the ambiguity of the grating lobes.

In some demonstrative aspects, as shown in FIG. 11, radar devices 1120 and/or 1140, may be configured to perform Tx beamforming, for example, to direct the Tx signals to one or more beamforming regions 1156, for example, including the overlapping FOV region, e.g., shown in FIG. 11.

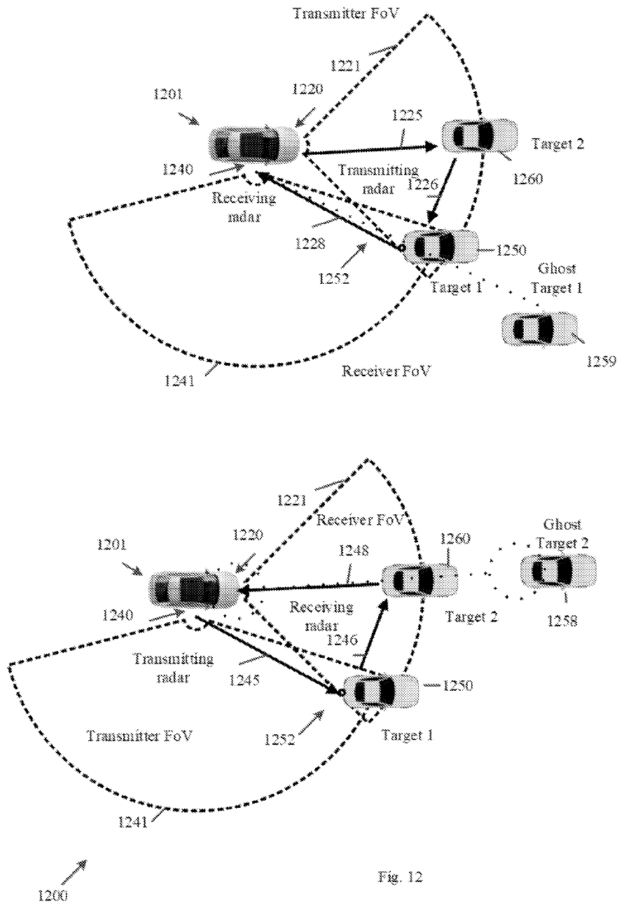

Reference is made to FIG. 12, which schematically illustrates a radar detection scheme 1200, in accordance with some demonstrative aspects.

In some demonstrative aspects, as shown in FIG. 12, a vehicle 1201 may include a first radar 1220 and a second radar 1240. For example, vehicle 1201 may include one or more elements of vehicle 100 (FIG. 1), and/or may perform one or more operations and/or functionalities of vehicle 100 (FIG. 1); first radar 1220 may include one or more elements of first radar 920 (FIG. 9), and/or may perform one or more operations and/or functionalities of first radar 920 (FIG. 9); and/or second radar 1240 may include one or more elements of second radar 940 (FIG. 9), and/or may perform one or more operations and/or functionalities of second radar 940 (FIG. 9).

In some demonstrative aspects, as shown in FIG. 12, radar 1220 may be configured to communicate radar signals in a first radar FOV 1221.

In some demonstrative aspects, as shown in FIG. 12, second radar 1240 may be configured to communicate radar signals in a second radar FOV 1241.

In some demonstrative aspects, as shown in FIG. 12, the first FOV 1221 and second radar FOV 1241 may partially overlap, e.g., in an overlapping FOV region 1252.

In some demonstrative aspects, as shown in FIG. 12, a first target 1250 may be located in the overlapping FOV region 1252.

In some demonstrative aspects, as shown in FIG. 12, a second target 1260 may be located in the FOV 1221.

In some demonstrative aspects, there may be a need to provide a technical solution to mitigate one or more ghost targets, which may be detected in a multipath scenario.

For example, the multipath scenario may result in a Tx signal, which may be transmitted from a radar, to be scattered by a first target, and the second target may reflect the scattered signal back to the radar. For example, the radar may detect a ghost target, for example, if the radar only takes into consideration an Rx angle, e.g., an Rx angle of the reflected signal as received at the radar. For example, the ghost target may be detected to be at a same angle of a last scattering target but at a different range from the last scattering target.

In one example, detection of the ghost target may be avoided, for example, by estimating both the Tx angle and the Rx angle corresponding to the Tx signal and the received signal, for example, in some radar implementations, which may depend on a structure of an antenna array. However, performing both Tx and Rx angle estimations may be costly, e.g., as it may require going over many different hypotheses of the Tx angle and the Rx angle.

In some demonstrative aspects, radar devices 1220 and 1240 may be configured to communicate signals according to a multipath scenario corresponding to the first multipath scenario described above. For example, radar devices 1220 and 1240 may be configured to communicate signals according to a multipath scenario including a first radar path of a Tx signal from the first radar 1220 and an Rx signal received by the second radar 1240 based on the Tx signal from the first radar 1220; and a second radar path including a Tx signal from the second radar 1240 and an Rx signal received by the first radar 1220 based on the Tx signal from the second radar 1240, e.g., as described below.

In some demonstrative aspects, a radar processor of vehicle 1201, e.g., radar processor 934 (FIG. 9), may be configured to detect and differentiate between ghost targets and actual targets, for example, based on the communications between the radar devices 1220 and 1240, e.g., as described below.

In some demonstrative aspects, as shown in FIG. 12, a Tx signal 1225 may be transmitted from the first radar 1220 towards the target 1260.

In some demonstrative aspects, as shown in FIG. 12, a scattered signal 1226 may be generated by a scattering of Tx signal 1225 from the target 1260 towards the target 1250.

In some demonstrative aspects, as shown in FIG. 12, a reflected signal 1228 may result from scattered signal 1226 being reflected from the target 1250 towards the second radar 1240.

In some demonstrative aspects, the radar processor of vehicle 1201, e.g., radar processor 934 (FIG. 9), may detect a ghost target 1259, for example, based on the Tx signal 1225 from radar device 1220 and the reflected signal 1228 received at radar device 1240.

In some demonstrative aspects, as shown in FIG. 12, the ghost target 1259 may be detected to be at a same angle of a last scattering target, e.g., the angle of the target 1250, but at a different range from the target 1250.

In some demonstrative aspects, as shown in FIG. 12, a Tx signal 1245 may be transmitted from the second radar 1240 towards the target 1250.

In some demonstrative aspects, as shown in FIG. 12, a scattered signal 1246 may be generated by a scattering of Tx signal 1245 from the target 1250 towards the target 1260.

In some demonstrative aspects, as shown in FIG. 12, a reflected signal 1248 may result from scattered signal 1246 being reflected from the target 1260 towards the first radar 1220.

In some demonstrative aspects, the radar processor of vehicle 1201, e.g., radar processor 934 (FIG. 9), may detect a ghost target 1258, for example, based on the Tx signal 1245 from radar device 1240 and the reflected signal 1248 received at radar device 1220.

In some demonstrative aspects, as shown in FIG. 12, the ghost target 1258 may be detected to be at a same angle of a last scattering target, e.g., the angle of the target 1260, but at a different range from the target 1260.

In some demonstrative aspects, the radar processor of vehicle 1201, e.g., radar processor 934 (FIG. 9), may be configured to differentiate the ghost targets 1258 and/or 1259 from the actual targets 1250 and/or 1260, e.g., as described below.

In some demonstrative aspects, the radar processor of vehicle 1201, e.g., radar processor 934 (FIG. 9), may be configured to identify that a detected potential target is to be classified as a ghost target, for example, based on a determination that the detected potential target appears to be detected in a first radar path, and that the detected potential target is not detected in a second radar path, e.g., as described below.

In some demonstrative aspects, as shown in FIG. 12, the radar processor of vehicle 1201, e.g., radar processor 934 (FIG. 9), may identify that the ghost target 1259 appears in a first radar path, e.g., the radar path including the Tx signal 1225 from the first radar 1220, and the reflected signal 1228, e.g., received by the second radar 1240.

In some demonstrative aspects, as shown in FIG. 12, the radar processor of vehicle 1201, e.g., radar processor 934 (FIG. 9), may identify that the ghost target 1259 does not appear in a second radar path, e.g., the radar path including the Tx signal 1245 from the second radar 1240, and the reflected signal 1248, e.g., received by the first radar 1220.

Accordingly, the radar processor of vehicle 1201, e.g., radar processor 934 (FIG. 9), may determine that the ghost target 1259 is to be classified and treated as a ghost target and not a real target.

In some demonstrative aspects, as shown in FIG. 12, the radar processor of vehicle 1201, e.g., radar processor 934 (FIG. 9), may identify that the ghost target 1258 appears in a first radar path, e.g., the radar path including the Tx signal 1245 from the first radar 1220, and the reflected signal 1248, e.g., received by the first radar 1220.

In some demonstrative aspects, as shown in FIG. 12, the radar processor of vehicle 1201, e.g., radar processor 934 (FIG. 9), may identify that the ghost target 1258 does not appear in a second radar path, e.g., the radar path including the Tx signal 1225 from the first radar 1220, and the reflected signal 1228, e.g., received by the second radar 1240.

Accordingly, the radar processor of vehicle 1201, e.g., radar processor 934 (FIG. 9), may determine that the ghost target 1258 is to be classified and treated as a ghost target and not a real target.

In some demonstrative aspects, the radar processor of vehicle 1201, e.g., radar processor 934 (FIG. 9), may be configured to validate that only target 1250 is in the overlapping FOV region 1252, while identifying that the ghost targets 1258 and/or 1259 are not to be treated as real targets.

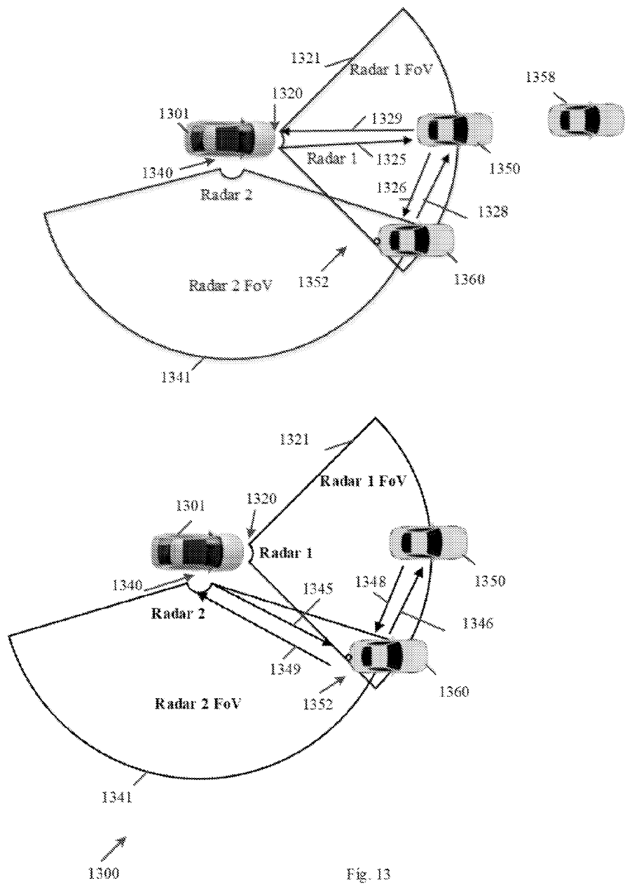

Reference is made to FIG. 13, which schematically illustrates a radar detection scheme 1300, in accordance with some demonstrative aspects.

In some demonstrative aspects, as shown in FIG. 13, a vehicle 1301 may include a first radar 1320 and a second radar 1340. For example, vehicle 1301 may include one or more elements of vehicle 100 (FIG. 1), and/or may perform one or more operations and/or functionalities of vehicle 100 (FIG. 1); first radar 1320 may include one or more elements of first radar 920 (FIG. 9), and/or may perform one or more operations and/or functionalities of first radar 920 (FIG. 9); and/or second radar 1340 may include one or more elements of second radar 940 (FIG. 9), and/or may perform one or more operations and/or functionalities of second radar 940 (FIG. 9).

In some demonstrative aspects, as shown in FIG. 13, radar 1320 may be configured to communicate radar signals in a first radar FOV 1321.

In some demonstrative aspects, as shown in FIG. 13, second radar 1340 may be configured to communicate radar signals in a second radar FOV 1341.

In some demonstrative aspects, as shown in FIG. 13, the first FOV 1321 and second radar FOV 1341 may partially overlap, e.g., in an overlapping FOV region 1352.

In some demonstrative aspects, as shown in FIG. 13, a first target 1360 may be located in the overlapping FOV region 1352.

In some demonstrative aspects, as shown in FIG. 13, a second target 1350 may be located in the FOV 1321.

In some demonstrative aspects, there may be a need to provide a technical solution to mitigate one or more ghost targets, which may be detected in a multipath scenario.

In some demonstrative aspects, radar devices 1320 and 1340 may be configured to communicate signals according to a multipath scenario corresponding to the second multipath scenario described above. For example, radar devices 1320 and 1340 may be configured to communicate signals according to a multipath scenario including a first radar path of a first Tx signal from the first radar 1320 to target 650, a first scattered signal from the target 1350, a first reflected signal reflected from target 1360 back to the target 1350, and a second reflected signal reflected back from the target 1350 to the first radar 1320; and a second radar path of a second Tx signal from the second radar 1340 to the target 1360, a second scattered signal from the target 1360, a third reflected signal reflected from the target 1350 back to the target 1360, and a fourth reflected signal reflected back from the target 1360 to the second radar 1340, e.g., as described below.

In some demonstrative aspects, a radar processor of vehicle 1301, e.g., radar processor 934 (FIG. 9), may be configured to detect and differentiate between ghost targets and actual targets, for example, based on the communications between the radar devices 1320 and 1340, e.g., as described below.

In some demonstrative aspects, as shown in FIG. 13, a Tx signal 1325 may be transmitted from the first radar 1320 towards the first target 1350.

In some demonstrative aspects, as shown in FIG. 13, a scattered signal 1326 may be generated by a scattering of Tx signal 1325 from the target 1350 towards the target 1360.

In some demonstrative aspects, as shown in FIG. 13, a first reflected signal 1328 may result from scattered signal 1326 being reflected from the target 1360 back towards the target 1350.

In some demonstrative aspects, as shown in FIG. 13, a second reflected signal 1329 may result from first reflected signal 1328 being reflected from the target 1350 back towards the first radar 1320.

In some demonstrative aspects, as shown in FIG. 13, a Tx signal 1345 may be transmitted from the second radar 1340 towards the target 1360.

In some demonstrative aspects, as shown in FIG. 13, a scattered signal 1346 may be generated by a scattering of Tx signal 1345 from the target 1360 towards the target 1350.

In some demonstrative aspects, as shown in FIG. 13, a first reflected signal 1348 may result from scattered signal 1346 being reflected from the target 1350 back towards the target 1360.

In some demonstrative aspects, as shown in FIG. 13, a second reflected signal 1349 may result from first reflected signal 1348 being reflected from the target 1360 back towards the first radar 1340.

In some demonstrative aspects, the radar processor of vehicle 1301, e.g., radar processor 934 (FIG. 9), may be configured to differentiate the ghost target 1358 from the actual targets 1350 and/or 1360, e.g., as described below.

In some demonstrative aspects, a radar processor of vehicle 1301, e.g., radar processor 934 (FIG. 9), may be configured to identify a ghost target 1358, for example, based on the signals communicated by both radars 1320 and 1340, e.g., as described below.

In some demonstrative aspects, the radar processor of vehicle 1301, e.g., radar processor 934 (FIG. 9), may be configured to identify that a detected potential target is to be classified as a ghost target, for example, based on a determination that the detected potential target appears to be detected in a first radar path, and that the detected potential target is not detected in a second radar path, e.g., as described below.

In some demonstrative aspects, as shown in FIG. 13, the radar processor of vehicle 1301, e.g., radar processor 934 (FIG. 9), may identify that the ghost target 1358 appears in a first radar path including, for example, the Tx signal 1325 from the first radar 1320 to target 1350, scattered signal 1326 from the target 1350, reflected signal 1328 reflected from the target 1360 to the target 1350, and reflected signal 1329 reflected back from the target 1350 to the first radar 1320.

In some demonstrative aspects, as shown in FIG. 13, the radar processor of vehicle 1301, e.g., radar processor 934 (FIG. 9), may identify that the ghost target 1358 does not appear in a second radar path including, for example, the Tx signal 1345 from the second radar 1340 to the target 1360, scattered signal 1346 from the target 1360, reflected signal 1348 reflected from the target 1350 back to the target 1360, and reflected signal 1349 reflected back from the target 1360 to the second radar 1340.

Accordingly, the radar processor of vehicle 1301, e.g., radar processor 934 (FIG. 9), may determine that the ghost target 1358 is to be classified and treated as a ghost target and not a real target.

Accordingly, the radar processor of vehicle 1301, e.g., radar processor 934 (FIG. 9), may validate that only targets 1350 and 1360 are valid.

In one example, when using a plurality of radars, e.g., radars 1320 and/or 1340, a ghost target, e.g., ghost target 1358, may appear in all paths described above with respect to the RCS diversity, may be if all surfaces of the scattering and/or reflecting targets line-up perfectly, which may be unlikely. Therefore, detection of appearance of a potential target in the first radar path and detection of disappearance of the potential target in the second radar path may allow identifying that the potential target is a ghost target.

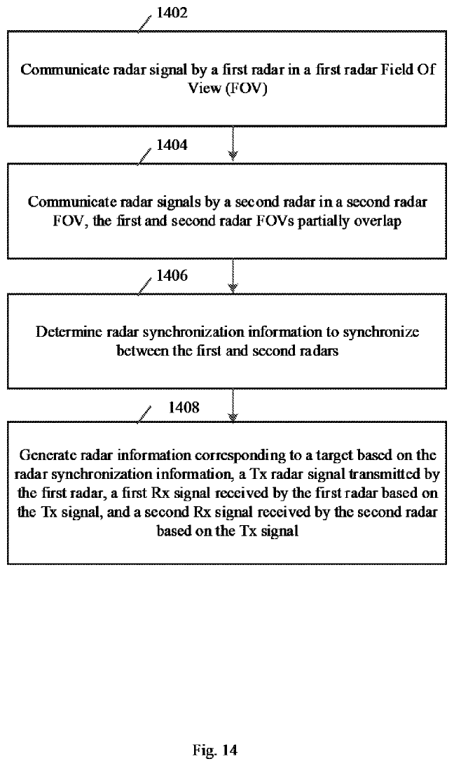

Reference is made to FIG. 14, which schematically illustrates a method of generating radar information based on radar synchronization information to synchronize between first and second radars, in accordance with some demonstrative aspects. For example, one or more of the operations of the method of FIG. 14 may be performed by a radar device, e.g., radar device 101 (FIG. 1), a radar, e.g., radars 920 and/or 940 (FIG. 9), and/or a radar processor, e.g., radar processor 834 (FIG. 8) and/or radar processor 934 (FIG. 9).

As indicated at block 1402, the method may include communicating radar signals by a first radar in a first radar FOV. For example, radar 920 (FIG. 9) may communicate the radar signals in the first radar FOV, e.g., as described above.

As indicated at block 1404, the method may include communicating radar signals by a second radar in a second radar FOV, for example, wherein the first and second radar FOVs partially overlap. For example, radar 940 (FIG. 9) may communicate the radar signals in the second radar FOV, which may partially overlap with the first radar FOV, e.g., as described above.

As indicated at block 1406, the method may include determining radar synchronization information to synchronize between the first and second radars. For example, radar processor 934 (FIG. 9) may determine the radar synchronization information to synchronize between first radar 920 (FIG. 9) and second radar 940 (FIG. 9), e.g., as described above.

As indicated at block 1406, the method may include generating radar information corresponding to a target based on the radar synchronization information, a Tx radar signal transmitted by the first radar, a first Rx signal received by the first radar based on the Tx radar signal, and a second Rx signal received by the second radar based on the Tx radar signal. For example, radar processor 934 (FIG. 9) may generate radar information 953 (FIG. 9) corresponding to target 950 (FIG. 9), for example, based on the radar synchronization information, Tx radar signal 925 (FIG. 9) transmitted by the first radar 920 (FIG. 9), Rx signal 926 (FIG. 9) received by the first radar 920 (FIG. 9) based on the Tx radar signal 925 (FIG. 9), and Rx signal 945 (FIG. 9) received by the second radar 940 (FIG. 9) based on the Tx radar signal 925 (FIG. 9), e.g., as described above.

Referring to FIG. 8, in some demonstrative aspects, a radar device, e.g., radar device 101 (FIG. 1), may include a plurality of radar front-ends (also referred to as “remote radar units”), e.g., radar fronts-ends 804, as described below.

In some demonstrative aspects, one or more, e.g., some or all, of the plurality of radar front-ends, e.g., radar fronts-ends 804, may be configured to provide radar Rx data 811, for example, to a radar processor, e.g., radar processor 834, e.g., as described below.

In some demonstrative aspects, radar processor 834 may be configured to process the radar Rx data 811 from the plurality of radar front-ends, for example, in a coherent and/or synchronized manner, e.g., as described below.

In some demonstrative aspects, radar processor 834 may be configured to process radar Rx data inputs from one or more of the plurality of radar front-ends 804, for example, by synchronizing between the plurality of radar front-ends 804, e.g., as described below.

In some demonstrative aspects, the plurality of radar front-ends 804 may be implemented by a MIMO radar, e.g., radar device 101 (FIG. 1), for example, to provide a wide aperture radar antenna, which may be formed, for example, based on a combination of the MIMO radar antennas 881 of the of the plurality of radar front-ends 804, e.g., as described below.

In one example, the wide aperture radar antenna may be implemented, for example, to achieve improved angular performance, for example, in terms of resolution and/or accuracy.

In some demonstrative aspects, the plurality of radar front-ends, e.g., radar front-ends 804, may be placed at different locations, for example, spaced apart at a distance, which may support utilization of the radar Rx data 811 from the remote radar units as radar information of a wide aperture antenna, e.g., as described below.

In one example, the wide aperture radar antenna may be implemented by locating the remote radar units at suitable distances from one another, for example, instead of utilizing a full-scale antenna system, which may be larger, more complex and/or more expensive.

In some demonstrative aspects, there may be a need to address one or more technical issues, for example, when utilizing the remote radar units, for example, to implement the wide aperture radar antenna, e.g., as described below.

In one example, the remote radar units may be kept synchronized, e.g., at a very high level of synchronization, e.g., a synchronization level of Picoseconds. However, keeping such synchronization may require advanced processing, and/or complex calculations and/or conversions, e.g., to accurately synchronize the remote radar units in a tight microwave scheme, e.g., a mmWave scheme.

In some demonstrative aspects, there may be one or more disadvantages, inefficiencies, and/or technical problems in an implementation based on synchronizing the remote radar units, for example, using cables and/or optic fibers, e.g., as described below.

In one example, an implementation using cables and/or optic fibers to communicate synchronization information between the remote radar units may not properly support the communication of phase information, which may be required to synchronize the remote antenna units.

In some demonstrative aspects, radar processor 834 may be configured to support a tight synchronization of remote radar units, e.g., radar front-ends 804, in a mmWave scheme, for example, based on an RF signal transmitted from a first remote radar unit, e.g., a first radar front-end 804, and received by one or more second remote radar units, e.g., a second radar front-end 804.

For example, the RF signal may be utilized to synchronize between the first remote radar unit and the one or more second remote radar units, for example, even without requiring any prior assumptions and/or limitations, for example, even without assuming a Line-of-Sight (LOS) free space between the remote radar units, e.g., as described below.

In some demonstrative aspects, the RF signal may be utilized to synchronize between the remote radar units in an efficient manner. In one example, the RF signal may be utilized to determine a real delay between the remote radar units, for example, even without performing advanced processing, complex calculations and/or conversions.

In some demonstrative aspects, radar processor 834 may be configured to determine a delay between first and second remote radar units, for example, based on an RF signal communicated between the first and second remote radar units.

For example, the RF signal may be transmitted from the first remote radar unit and received at the second remote unit. For example, the RF signal may be utilized for estimating the delay between the first and second remote radar units, e.g., in an accurate manner, for example, by locking on the RF signal, e.g., as described below.

In some demonstrative aspects, radar processor 834 may be configured to coherently process the radar Rx data 811 from the first radar unit 804, for example, based on the estimated delay between the first and second remote radar units 804, e.g., as described below.

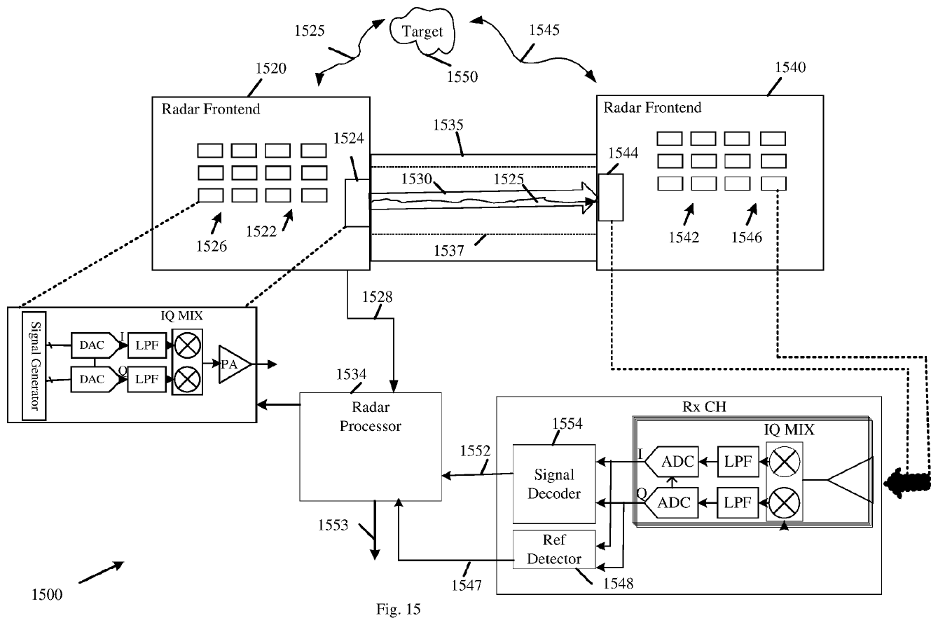

Reference is made to FIG. 15, which schematically illustrates elements of a radar device 1500 including a plurality of radar front-ends, in accordance with some demonstrative aspects. For example, radar device 101 (FIG. 1), and/or radar device 301 (FIG. 3), may include one or more elements of radar device 1500, and/or may perform one or more operations and/or functionalities of radar device 1500.

In some demonstrative aspects, radar device 1500 may include a plurality of radar front-ends, for example, including a first radar front-end 1520 and a second radar front-end 1540. For example, radar front-ends 1520 and/or 1540 may include one or more elements of radar front-end 804 (FIG. 8), and/or may perform one or more operations and/or functionalities of radar front-end 804 (FIG. 8).

In some demonstrative aspects, first radar front-end 1520 may include a plurality of Tx antennas 1522, and a Tx synchronization antenna 1524, e.g., as described below.

In some demonstrative aspects, the plurality of Tx antennas 1522 may be configured to transmit a Tx radar signal 1525 towards a target detection direction, e.g., corresponding to a target 1550, e.g., as described below.

In some demonstrative aspects, Tx radar signal 1525 may include a chirp signal, e.g., as described below. In other aspects, any other Tx radar signal may be used.

In some demonstrative aspects, the Tx synchronization antenna 1524 may be configured to transmit the Tx radar signal 1525 over a synchronization channel 1530 between radar frontend 1520 and radar frontend 1540, e.g., as described below.

In some demonstrative aspects, second radar front-end 1540 may include a plurality of Rx antennas 1542, and an Rx synchronization antenna 1544, e.g., as described below.

In some demonstrative aspects, the plurality of Rx antennas 1542 may be configured to receive an Rx radar signal 1545, for example, based on the Tx radar signal 1525 transmitted by the plurality of Tx antennas 1522.

In some demonstrative aspects, the Rx synchronization antenna 1544 may be configured to receive the Tx radar signal 1525 from the Tx synchronization antenna 1524, for example, via the synchronization channel 1530, e.g., as described below.

In some demonstrative aspects, second radar front-end 1540 may include a synchronization detector 1548 (“Ref detector”), which may be configured to determine synchronization information 1547, e.g., as described below.

In some demonstrative aspects, the synchronization detector 1548 may be configured to determine synchronization information 1547, for example, based on Tx radar signal 1525 received via the synchronization channel 1530, e.g., as described below.

In some demonstrative aspects, the synchronization detector 1548 may be configured to determine synchronization information 1547, for example, based on a time difference between a first timing and a second timing, e.g., as described below.

In some demonstrative aspects, the first timing may include a timing of receipt of the Tx radar signal 1525 from the Tx synchronization antenna 1524 at the Rx synchronization antenna 1544, and the second timing may include a time of a clock of second radar front-end 1540, e.g., as described below.

In some demonstrative aspects, synchronization detector 1548 may be configured to detect a timing of receipt of a chirp, or any other radar signal, in the Tx radar signal 1525 from the Tx synchronization antenna 1524 at the Rx synchronization antenna 1544.

In some demonstrative aspects, synchronization detector 1548 may be configured to determine the first timing based on the timing of receipt of the radar signal, e.g., the chirp, at the Rx synchronization antenna 1544.

In some demonstrative aspects, synchronization detector 1548 may be configured to compare between the first timing, e.g., the timing of receipt of the Tx radar signal 1525 from the Tx synchronization antenna 1524 at the Rx synchronization antenna 1544, and the second timing, e.g., the time of the clock of the second radar front-end 1540.

In some demonstrative aspects, synchronization detector 1548 may be configured to determine the synchronization information 1547, for example, based on a path delay, which may affect propagation of the Tx radar signal 1525 in a path 1537 between the Tx synchronization antenna 1524 and the Rx synchronization antenna 1544.

In some demonstrative aspects, radar processor 1534 may be configured to extract a phase difference, e.g., an accurate phase difference, between radar front-ends 1520 and 1540, for example, based on the path delay and the comparison between the first and second timings, e.g., as described below.

In some demonstrative aspects, second radar front-end 1540 may include a decoder 1554 (“Signal Decoder”) configured to provide Rx radar data 1552, for example, based on the Rx radar signal 1545. For example, decoder 1554 may include a chirp decoder to determine Rx radar data 1552 by decoding a received chirp in the radar Rx signal 1545. In other aspects, any other signal decoder may be implemented to decode the Rx signal 1545.

In some demonstrative aspects, second radar front-end 1540 may be configured to output the synchronization information 1547, and the Rx radar data 1552, e.g., as described below.

In some demonstrative aspects, radar device 1500 may include a radar processor 1534, which may be configured to determine radar information 1553. For example, radar processor 1534 may be configured to determine radar information 1553 including a convolution of the plurality of Tx antennas 1522 and the plurality of Rx antennas 1542.

For example, radar processor 1534 may be configured to determine radar information 1553 by processing the Rx radar data 1552 based, for example, on the synchronization information 1547, e.g., as described below.

For example, radar processor 834 (FIG. 8) may include one or more elements of radar processor 1534, and/or may perform one or more operations and/or functionalities of radar processor 1534; and/or radar information 813 (FIG. 8) may include radar information 1553.

In some demonstrative aspects, the second radar front-end 1540 may be configured to transmit a Tx radar signal towards the target detection direction, for example, in addition to, the Tx radar signal 1525 transmitted towards the target detection direction from first radar front-end 1520, e.g., as described below.

In some demonstrative aspects, the second radar front-end 1540 may include a plurality of Tx antennas 1546 configured to transmit an other Tx radar signal towards the target detection direction, e.g., towards target 1550.

In some demonstrative aspects, the first radar front-end 1520 may include a plurality of Rx antennas 1526 configured to receive an Rx radar signal (“the other Rx signal”) based on the other Tx radar signal transmitted by Tx antennas 1546.

In some demonstrative aspects, the first radar front-end 1520 may be configured to provide other Rx Data 1528, for example, based on the other Rx radar signal received by Rx antennas 1526.

In some demonstrative aspects, radar processor 1534 may be configured to process the Rx radar data 1552 and the other Rx radar data 1528, for example, based on the synchronization information 1547, to determine radar information 1553 of a MIMO radar antenna including a convolution of MIMO Rx antennas and MIMO Tx antennas, e.g., as described below.

In some demonstrative aspects, the MIMO Tx antennas may include the plurality of Tx antennas 1522 of the first radar front-end 1520 and the plurality of Tx antennas 1546 of the second radar front-end 1540; and/or the MIMO Rx antennas may include the plurality of Rx antennas 1526 of the first radar front-end 1520 and the plurality of Rx antennas 1542 of the second radar front-end 1540.

In some demonstrative aspects, radar device 1500 may include a physical channel 1535 configured to transfer the radar Tx signal 1525 via the synchronization channel 1530 in the path 1537 between the Tx synchronization antenna 1524 and the Rx synchronization antenna 1544, e.g., as described below.

In some demonstrative aspects, physical channel 1535 may be configured to isolate the Tx radar signal 1525 propagating via the synchronization channel 1530, for example, from the Tx radar signal 1525 transmitted by the plurality of Tx antennas 1522, e.g., as described below.

In some demonstrative aspects, radar device 1500 may include a flexible Printed Circuit Board (PCB) configured to tunnel the Tx radar signal 1525 via the path 1537 between the Tx synchronization antenna 1524 and the Rx synchronization antenna 1544, e.g., as described below.

In some demonstrative aspects, radar device 1500 may include an insulation coating on one or more surfaces along the path 1537 between the Tx synchronization antenna 1524 and the Rx synchronization antenna 1544, e.g., as described below.

In one example, the one or more surfaces along the path 1537 may include one or more surfaces of vehicle 100 (FIG. 1), for example, a surface of a bumper and/or any other surface of the vehicle, e.g., as described below.

In some demonstrative aspects, the insulation coating may be configured to tunnel the Tx radar signal via the path 1537 between the Tx synchronization antenna 1524 and the Rx synchronization antenna 1544.

In some demonstrative aspects, radar front-ends 1520 and 1540 may be controlled, e.g., by radar processor 1534, to jointly participate in radar activity, for example, by communicating radar signals transmitted from a first radar front-end to a second radar front end.

In some demonstrative aspects, radar processor 1534 may be configured to generate radar information 1553 by processing radar data from radar front-ends 1520 and 1540, e.g., coherently.

In some demonstrative aspects, the synchronization channel 1530 may be configured as a back channel between radar front-ends 1520 and 1540, for example, to allow radar front-end 1520 to send the Tx signal 1525, and to allow radar front-end 1540 to lock on the Tx signal 1525. For example, radar processor 1534 may be configured to evaluate phase differences between radar front-ends 1520 and 1540, for example, based on the synchronization information 1547.

In some demonstrative aspects, the communication of radar Tx signals over the synchronization channel 1530, e.g., the Tx signal 1525 transmitted from radar front-end 1520 and/or the Tx radar signal transmitted from radar front-end 1520 as described above, may support a technical solution of a wide aperture radar antenna, for example, while ensuring a virtual array MIMO concept.

In some demonstrative aspects, a same Tx pattern, e.g., chirps, for example, over a same frequency carrier signal or different frequency carrier signals, may be applied to the Tx radar signal 1525 propagating via the synchronization channel 1530 and the Tx radar signal 1525 transmitted by the plurality of Tx antennas 1522. For example, this configuration of the Tx pattern may support implementation of similar hardware design and/or components for decoder 1554 and synchronization detector 1548, which may reduce complexity of radar front-end 1540.

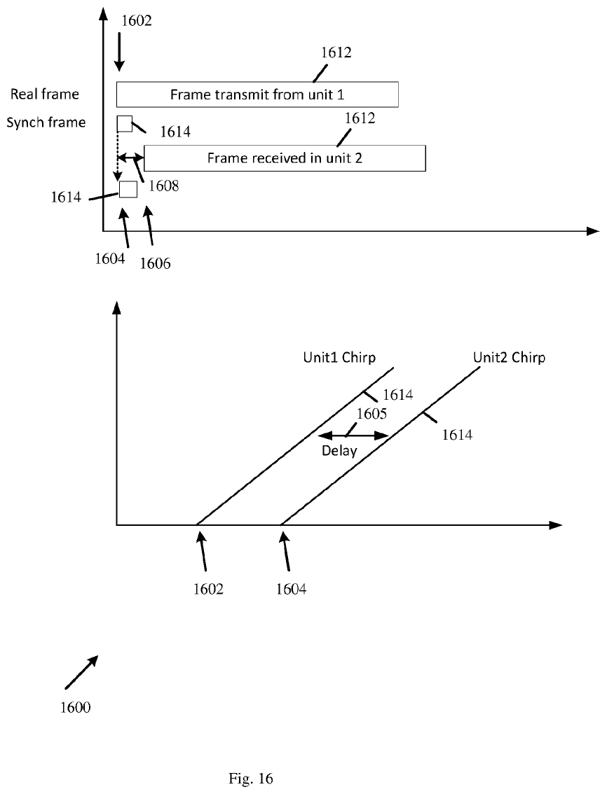

Reference is made to FIG. 16, which schematically illustrates timing diagrams 1600 corresponding to radar signals communicated between radar front-ends, in accordance with some demonstrative aspects.

In one example, timing diagrams 1600 depict a concept of comparing a delay, e.g., a chirp delay, of a Frequency-modulated continuous-wave (FMCW) radar, for example, to synchronize between a first radar front-end and a second radar front-end, e.g., radar front-ends 1520 and 1540 (FIG. 15).

In some demonstrative aspects, as shown in FIG. 16, a first time 1602 may include a timing of transmission of a radar frame 1612 of a Tx radar signal, e.g., Tx radar signal 1525 (FIG. 15), via a plurality of Tx antennas of a first radar front-end, e.g., the plurality of Tx antennas 1522 (FIG. 15) of the first radar front-end 1520 (FIG. 15).

In some demonstrative aspects, as shown in FIG. 16, the first time 1602 may also include a timing of transmission of a synchronization frame 1614 of the Tx radar signal via a Tx synchronization antenna of the first radar front-end, e.g., Tx synchronization antenna 1524 (FIG. 15).

In some demonstrative aspects, as shown in FIG. 16, a second time 1604 may include a timing of receipt of the synchronization frame 1614 from the Tx synchronization antenna at an Rx synchronization antenna of a second radar front-end, e.g., Rx synchronization antenna 1544 (FIG. 15) of radar front-end 1540 (FIG. 15).

In some demonstrative aspects, as shown in FIG. 16, a third time 1606 may include a timing of receipt of radar frame 1612 at a plurality of Rx antennas of the second radar front-end, e.g., the plurality of Rx antennas 1542 (FIG. 15).

In some demonstrative aspects, as shown in FIG. 16, there may be a delay 1608 between a time, e.g., time 1606, at which the second radar front-end receives radar frame 1612, and a time, e.g., time 1602, at which the first radar antenna transmits radar frame 1612. For example, the delay 1608 may result from a path travelled by radar frame 1612. For example, delay 1608 may include a radar component and a synchronization component.

For example, the radar component may include a delay of the propagation of Tx radar signal 1525 (FIG. 15) transmitted from the plurality of Tx antennas 1522 (FIG. 15), reflected by target 1550 (FIG. 15), and received by the plurality of Rx antennas 1542 (FIG. 15). For example, the synchronization delay may be based on a time difference between the first and second radar front-ends.

In some demonstrative aspects, as shown in FIG. 16, there may be a delay 1605 between a time, e.g., time 1602, at which the second radar front-end transmits the synchronization frame 1614, and a time, e.g., time 1604, at which the second radar front end receives the synchronization frame 1614.

In some demonstrative aspects, the delay 1605 may include a path delay and the synchronization delay. For example, the path delay may be generated by the path 1537 (FIG. 15) during the propagation of Tx radar signal 1525 (FIG. 15) transmitted from the Tx synchronization antenna 1524 (FIG. 15) and received by the Rx synchronization antenna 1544 (FIG. 15) via path 1537 (FIG. 15).

In some demonstrative aspects, the path delay may include a deterministic delay, which may be measured, e.g., a priori. Therefore, the synchronization frame 1614 may be implemented to accurately determine the synchronization delay, and to synchronize between the first and second radar front-ends, e.g., in real time.

In some demonstrative aspects, the synchronization frame 1614 (FIG. 16) may be implemented to efficiently synchronize between the first and second radar front-ends. For example, the synchronization frame 1614 (FIG. 16) may have a short duration, and the propagation time of the synchronization frame 1614 (FIG. 16) may be deterministic.

Referring back to FIG. 15, radar processor 1534 may be configured to determine the synchronization delay between radar frontend 1540 and radar frontend 1520, for example, based on the path delay of path 1537 and a comparison between the time 1604 (FIG. 16) of receipt of the synchronization frame 1614 (FIG. 16) and a time of a clock of radar front end 1540.

In some demonstrative aspects, path 1537 may be configured to guarantee a “safe” passage of the synchronization frame 1614 (FIG. 16) from Tx synchronization antenna 1524 to Rx synchronization antenna 1544. For example, reflections from the radar frame 1612 (FIG. 16) at the second radar front-end may be very close, which may cause interference to the synchronization frame 1614 (FIG. 16).

In some demonstrative aspects, radar processor 1534 may be configured to set a gain of the synchronization signal, e.g., Tx radar signal 1525 (FIG. 15), for example, to ensure that the synchronization signal is not saturated, for example, when received at the radar front-end 1540, for example, to ensure the “safe” passage of a synchronization signal.

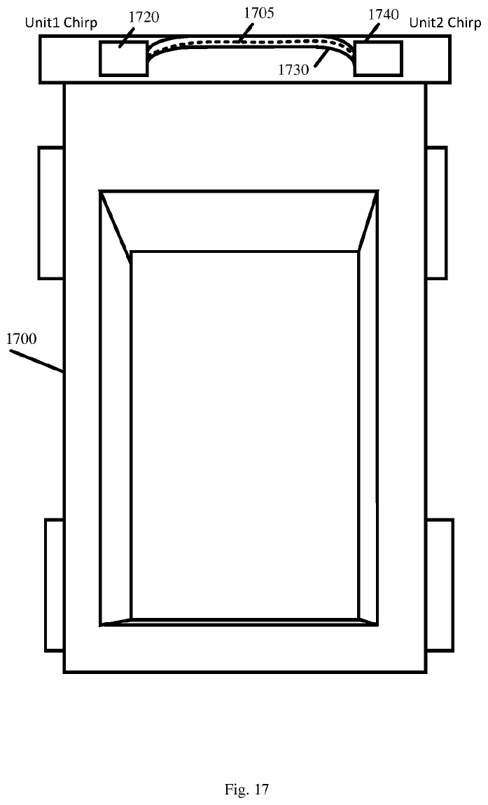

Reference is made to FIG. 17, which schematically illustrates a deployment of a first radar front-end 1720 and a second radar front-end 1740 in a vehicle 1700. For example, vehicle 1700 may include one or more elements of Vehicle 100 (FIG. 1), and/or may perform one or more operations and/or functionalities of Vehicle 100 (FIG. 1); first radar front-end 1720 may include one or more elements of radar front-end 1520 (FIG. 15), and/or may perform one or more operations and/or functionalities of radar front-end 1520 (FIG. 15); and/or second radar front-end 1740 may include one or more elements of radar front-end 1540 (FIG. 15), and/or may perform one or more operations and/or functionalities of radar front-end 1540 (FIG. 15).

In some demonstrative aspects, as shown in FIG. 17, vehicle 1700 may include a physical channel 1730 configured to transfer a Tx radar signal via a synchronization channel in a path 1705 between the first radar front-end 1720 and the second radar front-end 1740. For example, path 1705 may be configured to transfer Tx radar signal 1525 (FIG. 15) radar front-end 1720 to radar front-end 1740.

In some demonstrative aspects, physical channel 1730 may be implemented within one or more parts of vehicle 1700, e.g., in a bumper of the vehicle or any other part of vehicle 1700, for example, by employing one or more installation schemes, e.g., as described below.

In some demonstrative aspects, the installation schemes may be configured to reject external interference from affecting the Tx radar signal, to keep an attenuated multipath for the Tx radar signal, to control a gain level of the Tx radar signal, e.g., to avoid saturation in radar front-end 1740, and/or to maintain power of the Tx radar signal at a level, which may enable detection of the Tx radar signal, e.g., a power above other noises.

In some demonstrative aspects, a first installation scheme may include adding a coating on parts of vehicle 1700, e.g., a bumper or other element. For example, the coating may be configured to allow isolation of the synchronization channel, for example, from outside world interferences, multipath, and/or from self-interferences, e.g., which may be caused by radar front-ends 1720 and/or 1740.

For example, the coating may include metal tapes, dielectric materials patterned on the parts of vehicle 1700, and/or any other additional or alternative materials.

In some demonstrative aspects, a second installation scheme may include adding physical elements, e.g., on one or more parts of vehicle 1700, for example, to tunnel and/or guide the Tx radar signal via path 1705.

In one example, the physical elements may include cylinders with isolating materials.

In another example, the physical elements may include a film supporting high frequency tunneling.

In another example, the physical elements may include a flexible PCB with printed antennas.

In another example, the physical elements may include a waveguide.

In other aspects, any other physical elements may be used.

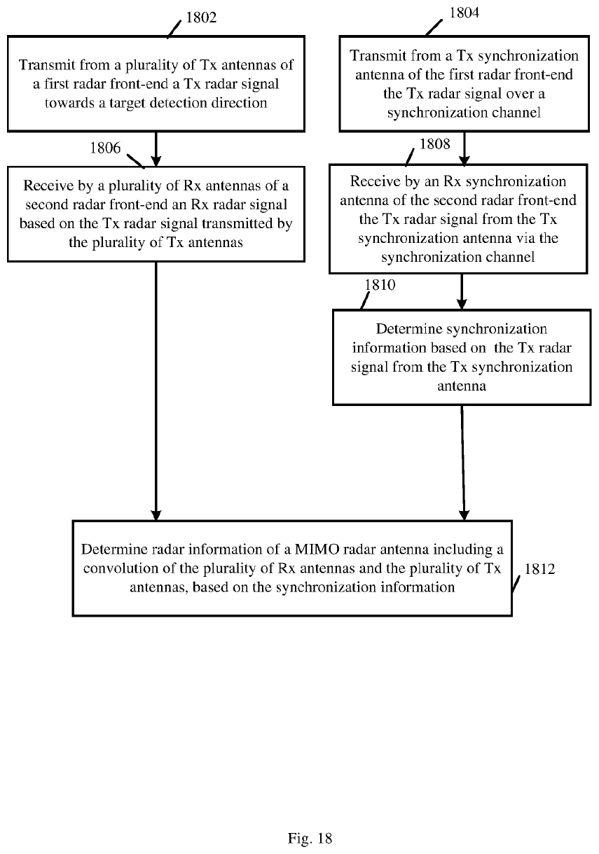

Reference is made to FIG. 18, which schematically illustrates a method of synchronizing between a plurality of radar front-ends, in accordance with some demonstrative aspects. For example, one or more of the operations of the method of FIG. 18 may be performed by one or more elements of a radar front-end, e.g., radar front-end 1520 and/or 1540 (FIG. 15), a radar processor, e.g., radar processor 834 (FIG. 8) and/or radar processor 1534 (FIG. 15), and/or a processor, e.g., processor 832 (FIG. 8).

As indicated at block 1802, the method may include transmitting a Tx radar signal from a plurality of Tx antennas of a first radar front-end towards a target detection direction. For example, processor 1534 (FIG. 15) may be configured to control the plurality of Tx antennas 1522 (FIG. 15) to transmit the Tx radar signal 1525 (FIG. 15) towards the target detection direction, e.g., as described above.

As indicated at block 1804, the method may include transmitting from a Tx synchronization antenna of the first radar front-end the Tx radar signal over a synchronization channel. For example, Tx synchronization antenna 1524 (FIG. 15) may transmit the Tx radar signal 1525 (FIG. 15) over the synchronization channel 1530 (FIG. 15), e.g., as described above.

As indicated at block 1806, the method may include receiving by a plurality of Rx antennas of a second radar front-end an Rx radar signal based on the Tx radar signal transmitted by the plurality of Tx antennas. For example, the plurality of Rx antennas 1542 (FIG. 15) may receive the Rx radar signal 1545 (FIG. 15) based on the Tx radar signal 1525 (FIG. 15), e.g., as described above.

As indicated at block 1808, the method may include receiving, by an Rx synchronization antenna of the second radar front-end, the Tx radar signal from the Tx synchronization antenna via the synchronization channel. For example, Rx synchronization antenna 1544 (FIG. 15) may receive the Tx radar signal from the Tx synchronization antenna 1525 (FIG. 15) via the synchronization channel 1530 (FIG. 15), e.g., as described above.

As indicated at block 1810, the method may include determining synchronization information based on the Tx radar signal from the Tx synchronization antenna. For example, synchronization detector 1548 (FIG. 15) may determine the synchronization information based on the Tx radar signal 1525 (FIG. 15) from the Tx synchronization antenna 1524 (FIG. 15), e.g., as described above.

As indicated at bock 1812, the method may include determining radar information of a MIMO radar antenna including a convolution of the plurality of Rx antennas and the plurality of Tx antennas, based on the synchronization information. For example, processor 1534 (FIG. 15) may be configured to determine the radar information 1553 (FIG. 15) of the MIMO radar antenna including the convolution of the plurality of Rx antennas 1542 (FIG. 15) and the plurality of Tx antennas 1522 (FIG. 15), based on the synchronization information 1527 (FIG. 15), e.g., as described above.

Referring to FIG. 8, in some demonstrative aspects, radar processor 834 may be configured to process radar data of a radar device, e.g., radar device 101 (FIG. 1), which may be implemented as part of a vehicle, for example, an autonomous vehicle, e.g., vehicle 100 (FIG. 1).

In some demonstrative aspects, there may be a need to provide a technical solution to protect a radar device, e.g., radar device 101 (FIG. 1), from attacks, e.g., by hackers and/or any other attackers, e.g., as described below.

For example, a radar device, e.g., radar device 101 (FIG. 1), may be an important, or even critical, safety component in an autonomous driving platform, e.g., vehicle 100 (FIG. 1), and/or any other system or platform. For example, the radar device may be relied on for safety related decisions, as the radar device may be capable of sensing targets with high resolution and/or accuracy. For example, a radar device may be less prone to weather effects, for example, compared to other sensing systems, e.g., camera-based sensing systems. Accordingly, the radar device may be important, or even critical, in some environments and/or use cases, for example, for sensing targets in bad weather conditions.

In some demonstrative aspects, the implementation of the radar device as an important, or even critical, safety component of the autonomous driving platform may make the radar device a target for attackers and/or hackers.

For example, one or more security and/or safety attacks may be constructed to manipulate decisions of the radar device.

In one example, a security and/or safety attack may attempt to manipulate a radar system to determine that a target exists, e.g., that there is a close hazard, while no real target may actually be present. As a result, the security and/or safety attack may cause the radar system to trigger one or more operations, e.g., an emergency break and/or any other operation.

In another example, a security and/or safety attack may attempt to manipulate a radar system to determine one or more false properties and/or attributers with respect to a target. For example, an attacker may attempt to manipulate the radar system to determine an erroneous location and/or speed of a target. In one example, the attacker may attempt to manipulate the radar system to determine that a location of the target is farther away from a real location of the target and/or that the target is moving slower than it really is. As a result of these falsely-detected properties, the autonomous platform may ignore the target, which can lead to an accident.

Some radar systems may be based on periodic radar signals, e.g., chirp signals, Frequency Modulated Continues Wave (FMCW) signals, and/or any other periodic signals. For example, chirp signals may be implemented by radar systems to support use of an analog de-chirp match filter. However, implementation of periodic signals may make a radar system more vulnerable to attacks, e.g., relay attacks, which may make use of a repeated pattern in the periodic signals.

For example, a replay attack (also referred to as a “spoofing attack”) may include an attack, in which an attacker records a first instance of a radar signal and replays it, for example, in a certain way, for example, to manipulate the radar system.

For example, the attacker may use the replay attack to manipulate the radar system to determine a false target and/or to determine one or more false properties and/or attributers of a target, e.g., a false range, a false Doppler, and/or a false angle.

For example, a radar signal design, which may enable predicting most of the radar signal, for example, by looking only on a small portion of the radar signal, may be more prone to spoofing attacks and/or manipulations.

In some demonstrative aspects, a resilient radar design, which may be resilient to such replay attacks, may be implemented by configuring a radar device to transmit radar signals in a way, which may reduce, or even eliminate, the possibility of an attacker to predict and/or replay portions of the radar transmissions, e.g., as described below. For example, the resilient radar design may allow the radar device to detect and/or ignore such replay attacks.

In some demonstrative aspects, radar processor 834 may configure radar frontend 804 to communicate radar frames according to a radar transmission scheme, which may be configured to mitigate, or even prevent, a possibility of a replay attack, e.g., as described below.

In some demonstrative aspects, radar processor 834 may be configured to process radar data, which may include, for example, information of a radar frame, e.g., as described below. In other aspects, the radar data may include any other type and/or form of radar data, e.g., intermediate data, and/or processed data, which may be based on the radar Rx data 811.

In some demonstrative aspects, a radar frame may correspond to a plurality of range values, a plurality of Doppler values, a plurality of Rx channels, and a plurality of Tx channels.

In some demonstrative aspects, the plurality of range values may include a plurality of range bins, which may be configured, for example, based on a setting and/or implementation of a radar device implementing radar processor 834, e.g., radar device 101 (FIG. 1).

In some demonstrative aspects, the plurality of Doppler values may include a plurality of Doppler bins, which may be configured, for example, based on a setting and/or implementation of the radar device implementing radar processor 834, e.g., radar device 101 (FIG. 1).

In some demonstrative aspects, the plurality of Rx channels may correspond to the plurality of Rx antennas 816 and/or Rx chains 812.

In some demonstrative aspects, the plurality of Tx channels may correspond to the plurality of Tx antennas 814 and/or Tx chains 810.

In some demonstrative aspects, a range-Doppler-bin may correspond to a combination of a range value of the plurality of range values and a Doppler value of the plurality of Doppler values. For example, the range-Doppler bin may include radar data corresponding to the range value and the Doppler value.

In some demonstrative aspects, radar processor 834 may configure radar frontend 804 to communicate radar frames according to a radar transmission scheme, which may be configured to mitigate, or even prevent, a replay attack (“intra-frame replay attack”) within a transmitted radar frame, e.g., as described below. For example, in an intra-frame replay attack, an attacker may attempt to learn and/or record a first radar signal transmitted within a first portion of radar frame, and to replay the first radar signal to manipulate a second, subsequent, radar signal in a second portion of the same radar frame.

In some demonstrative aspects, radar processor 834 may configure radar frontend 804 to communicate radar frames according to a radar transmission scheme, which may be configured to mitigate, or even prevent, a replay attack (“inter-frame replay attack”) between transmitted radar frames. For example, in an inter-frame replay attack, an attacker may attempt to learn and/or record a first radar signal transmitted within a first radar frame, and to replay the first radar signal to manipulate a second, subsequent, radar signal in a second, subsequent radar frame.

In some demonstrative aspects, radar frontend 804 may be configured to communicate radar frames according to a radar scheme, which may be configured to remove a periodicity from the radar transmissions, e.g., as described below. For example, removing the periodicity from the radar transmissions may provide a technical solution to mitigate, or even prevent, spoofing attacks.

In some demonstrative aspects, one or more technical aspects may be addressed, for example, when removing the periodicity from the radar transmissions, e.g., as described below.

In some demonstrative aspects, a processing scheme for processing the radar signals may be configured to mitigate, or avoid, processing complexities, which may result from removing the periodicity from radar transmissions, e.g., as described below.

In some demonstrative aspects, the processing scheme for processing the radar signals may apply matched filtering techniques and/or decimation techniques for processing received radar signals. For example, these techniques may be implemented instead of signal folding techniques, which may be suitable for periodic signals, e.g., as described below.

In some demonstrative aspects, radar processor 834 may be configured to control, cause, trigger, and/or instruct transmitter 883 to transmit a sequence of radar frames via Tx antenna 814, e.g., as described below.

In some demonstrative aspects, radar processor 834 may be configured to control, cause, trigger, and/or instruct transmitter 883 to transmit a radar frame of the sequence of radar frames, for example, by transmitting a non-periodic Tx radar signal having a non-periodic pattern within the radar frame, e.g., as described below.

Some demonstrative aspects are described with reference to a radar scheme configured with respect to radar signals transmitted via a Tx antenna and received via an Rx antenna, e.g., as described below.

In other aspects, a radar scheme may be configured with respect to radar signals transmitted via a plurality of Tx antennas and received via a plurality of Rx antennas, e.g., as described below. For example, the radar scheme may be configured with respect to radar signals communicated by a MIMO radar antenna including a plurality of Tx antennas and a plurality of Rx antennas.

In some demonstrative aspects, radar processor 834 may be configured to generate the non-periodic Tx radar signal, for example, by applying a reference code to a periodic Tx radar signal having a periodic pattern, e.g., as described below.

In some demonstrative aspects, the periodic Tx radar signal may include a chirp signal, e.g., as described below.

In other aspects, the periodic Tx radar signal may include any other signal.

In some demonstrative aspects, the reference code may be configured, for example, such that the non-periodic Tx radar signal may support radar processing, for example, for range and/or Doppler estimation, e.g., as described below.

In some demonstrative aspects, the reference code may be configured, for example, such that the non-periodic Tx radar signal may be generated based on the periodic Tx radar signal, while removing a periodicity of the periodic Tx radar signal, e.g., as described below.

In some demonstrative aspects, the reference code may be configured, for example, such that the non-periodic Tx radar signal may be resilient to spoofing by an attacker, e.g., as described below.

In some demonstrative aspects, the reference code may be configured, for example, such that the non-periodic Tx radar signal may not be suitable for use in a replay attack. For example, the reference code may be configured, for example, such that one portions of the non-periodic Tx radar signal may not be suitable for replaying as another portion of the non-periodic Tx radar signal.

In some demonstrative aspects, the reference code may be configured to be orthogonal to itself, for example, after a Doppler shift, e.g., as described below.

In some demonstrative aspects, the reference code may include a random reference code, e.g., as described below.

In some demonstrative aspects, the reference code may include a predefined non-periodic pattern, e.g., as described below.

In other aspects, the reference code may include any other code and/or pattern.

In some demonstrative aspects, radar processor 834 may be configured to generate the non-periodic Tx radar signal, for example, by multiplying the reference code by the periodic Tx radar signal, e.g., as described below.

In other aspects, radar processor 834 may be configured to generate the non-periodic Tx radar signal by applying the reference code to the periodic Tx radar signal based on any other method.

In some demonstrative aspects, receiver 885 may receive a radar Rx signal, for example, based on the non-periodic Tx radar signal, e.g., as transmitted by transmitter 883, e.g., as described below.

In some demonstrative aspects, radar processor 834 may be configured to control, cause, trigger, and/or instruct receiver 885 to receive the radar Rx signal via at least one Rx antenna 816, e.g., as described below.

In some demonstrative aspects, radar processor 834 may be configured to control, cause, trigger, and/or instruct receiver 885 to generate a digital Rx signal, for example, based on the radar Rx signal, e.g., as described below. For example, the digital Rx signal may be provided to radar processor 834 as part of Rx radar data 811.

In some demonstrative aspects, radar processor 834 may be configured to generate radar information 813, for example, based on the digital Rx signal, e.g., as described below.

In some demonstrative aspects, radar processor 834 may be configured to process the digital Rx signal, for example, based on the periodic Tx radar signal and the reference code, e.g., as described below.

In some demonstrative aspects, radar processor 834 may configure a length of the radar frame, for example, such that the radar frame may be long enough to support radar processing, e.g., Doppler estimation, with a required level of accuracy, e.g., a relatively fine Doppler accuracy.

In some demonstrative aspects, radar processor 834 may be configured to configure a bandwidth of the radar frame, for example, such that the bandwidth of the radar frame may be wide enough to support radar processing, e.g., range estimation, with a required level of accuracy, e.g., a relatively high range accuracy.

In some demonstrative aspects, a number of samples to be processed per radar frame may be based on the length of the radar frame and/or the bandwidth of the radar frame. For example, a relatively large number of samples per frame may be used when processing a long radar frame having a high bandwidth. For example, a processing complexity of processing the radar frame may increase based on the number of samples to be processed per frame.

In some demonstrative aspects, radar processor 834 may be configured to process the digital Rx signal according to a matched-filtering scheme, which may be configured, for example, to support reduced processing complexity, e.g., as described below.

In some demonstrative aspects, radar processor 834 may be configured to process the digital Rx signal according to a decimation scheme, which may be configured, for example, to support reduced processing complexity, e.g., as described below.

In some demonstrative aspects, radar processor 834 may be configured to transform the digital Rx signal into a frequency-domain radar Rx signal in a frequency-domain, e.g., as described below.

In some demonstrative aspects, radar processor 834 may be configured to determine cross-correlation (XCORR) data corresponding to a plurality of Doppler values, for example, by multiplying the frequency-domain radar Rx signal by a plurality of coded reference signals corresponding to the plurality of Doppler values, respectively, e.g., as described below.

In some demonstrative aspects, a coded reference signal corresponding to a Doppler value may be based, for example, on the reference code, the periodic Tx signal and the Doppler value, e.g., as described below.

In other aspects, the coded reference signal corresponding to the Doppler value may be determined based on any other additional or alternative parameters.

In some demonstrative aspects, radar processor 834 may be configured to generate range-Doppler data, for example, by transforming the XCORR data to a time-domain, e.g., as described below.

In some demonstrative aspects, radar processor 834 may include a plurality of digital matched filters to multiply the frequency-domain radar Rx signal by the plurality of coded reference signals, respectively, e.g., as described below.

In some demonstrative aspects, a digital matched filter corresponding to the Doppler value may be configured to generate XCORR data corresponding to the Doppler value, for example, by multiplying the frequency-domain radar Rx signal by the coded reference signal corresponding to the Doppler value, e.g., as described below.

In some demonstrative aspects, radar processor 834 may be configured to decimate the XCORR data into decimated XCORR data, e.g., as described below.

In some demonstrative aspects, radar processor 834 may be configured to generate the range-Doppler data, for example, by transforming the decimated XCORR data into the time-domain, e.g., as described below.

In some demonstrative aspects, radar processor 834 may be configured to decimate the XCORR data, for example, according to a decimation factor of at least 50, e.g., as described below.

In some demonstrative aspects, radar processor 834 may be configured to decimate the XCORR data, for example, according to a decimation factor of at least 100, e.g., as described below.

In some demonstrative aspects, radar processor 834 may be configured to decimate the XCORR data, for example, according to a decimation factor of at least 200, e.g., as described below.

In some demonstrative aspects, radar processor 834 may be configured to decimate the XCORR data, for example, according to a decimation factor of at least 500, e.g., as described below.

In other aspects, radar processor 834 may be configured to decimate the XCORR data, for example, according to any other decimation factor.

In some demonstrative aspects, radar processor 834 may be configured to transform the digital Rx signal into the frequency-domain Rx signal, for example, by applying a Fast Fourier Transform (FFT) to the digital Rx signal, e.g., as described below.

In other aspects, radar processor 834 may be configured to transform the digital Rx signal into the frequency-domain Rx signal according to any other time-domain to frequency-domain conversion.

In some demonstrative aspects, radar processor 834 may be configured to transform the decimated XCORR data into the time domain, for example, by applying an Inverse FFT (IFFT) to the decimated XCORR data, e.g., as described below.

In other aspects, radar processor 834 may be configured to transform the decimated XCORR data into the time domain according to any other frequency-domain to time-domain conversion.

In some demonstrative aspects, a ratio between an FFT size of the FFT and an IFFT size of the IFFT may be based, for example, on the decimation factor of the decimated XCORR data relative to the XCORR data, e.g., as described below.

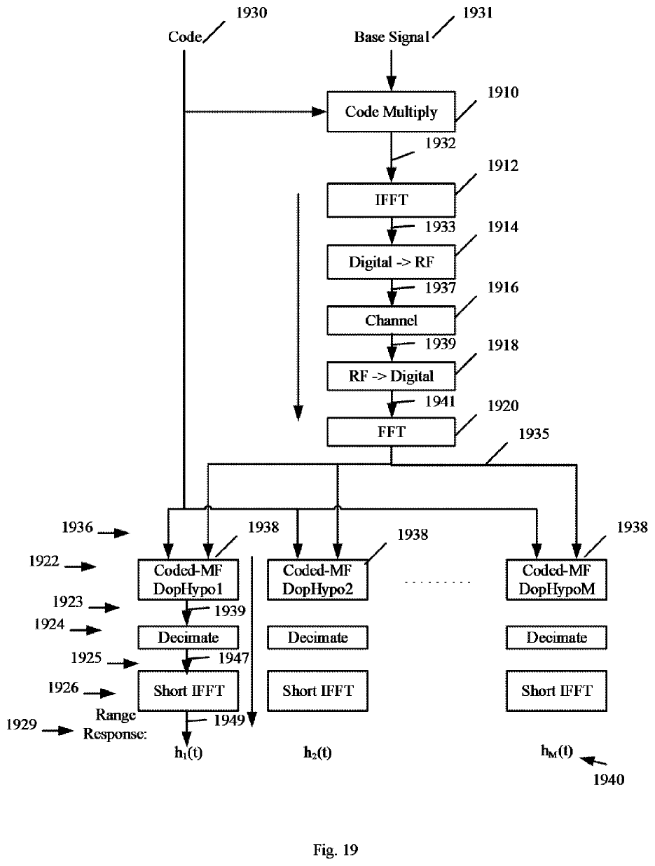

Reference is made to FIG. 19, which schematically illustrates a method of radar processing based on a non-periodic Tx radar signal, in accordance with some demonstrative aspects.

In some demonstrative aspects, one or more operations of the method of FIG. 19 may be implemented with respect to radar transmissions utilizing a Tx antenna to transmit a Tx radar signal, and an Rx antenna to receive an Rx radar signal based on the Tx radar signal, e.g., as described below. In other aspects, one or more operations of the method of FIG. 19 may be applied with respect to radar transmissions utilizing a plurality of Tx antennas and/or a plurality of Rx antennas. In one example, the radar scheme of FIG. 19 may be applied with respect to radar transmissions utilizing a MIMO radar antenna including a plurality of Tx antennas and a plurality of Rx antennas.

In some demonstrative aspects, radar processor 834 (FIG. 8) may be configured to control, cause, and/or trigger radar frontend 804 to communicate a radar frame according to one or more operations of the method of FIG. 19, and/or radar processor 834 (FIG. 8) may be configured to process radar information based on the radar frame according to one or more operations of the method of FIG. 19, e.g., as described below.

In some demonstrative aspects, as indicated at block 1910, the method may include generating a non-periodic Tx radar signal 1932 in a frequency domain, for example, by multiplying a periodic Tx radar signal 1931 by a reference code 1930, e.g., in the frequency-domain. For example, radar processor 834 (FIG. 8) may generate the non-periodic Tx radar signal 1932, for example, by multiplying the periodic Tx radar signal 1931 by the reference code 1930.

In some demonstrative aspects, as indicated at block 1912, the method may include transforming the non-periodic Tx radar signal 1932 into a time-domain digital non-periodic Tx radar signal 1933, for example, by applying an IFFT to the non-periodic Tx radar signal 1932. For example, radar processor 834 (FIG. 8) may transform the non-periodic Tx radar signal 1932 into the time-domain non-periodic Tx radar signal 1933.

In some demonstrative aspects, as indicated at block 1914, the method may include transforming the digital non-periodic Tx radar signal 1933 into a non-periodic RF Tx radar signal 1937. For example, transmitter 835 (FIG. 8) may transform the non-periodic Tx radar signal 1933 into the non-periodic RF Tx radar signal 1937.

In some demonstrative aspects, as indicated at block 1916, the method may include transmitting the non-periodic RF Tx radar signal 1937 over a wireless channel. For example, radar processor 834 (FIG. 8) may control, cause, trigger, and/or instruct transmitter 883 (FIG. 8) to transmit the non-periodic RF Tx radar signal 1937 over a wireless channel, for example, via the Tx antenna 814 (FIG. 8).

In some demonstrative aspects, as indicated at block 1918, the method may include receiving a radar Rx signal 1939, which may be based on the non-periodic RF Tx radar signal 1937, and generating a digital Rx signal 1941, for example, based on the radar Rx signal 1937. For example, receiver 885 (FIG. 8) may receive the radar Rx signal 1939 via the Rx antenna 816 (FIG. 8), and may generate the digital Rx signal 1941, for example, based on the radar Rx signal 1939.

In some demonstrative aspects, the method may include processing digital Rx signal 1941 based on one or more processing techniques, which may be configured based on the non-periodicity of the non-periodic Tx radar signal 1932, e.g., as described below.

For example, the digital Rx signal 1941 may be processed based on a digital matched-filter technique, which may be configured according to the non-periodic Tx radar signal 1932. In one example, the digital matched-filter technique may be used, for example, instead of analog de-chirp methods, which may be suitable for processing periodic chirp signals.

In some demonstrative aspects, processing the digital Rx signal 1941 may include correlating between the digital Rx signal 1941 and a reference sequence, which may represent, for example, the non-periodic RF Tx radar signal 1937, e.g., as described below.

In some demonstrative aspects, correlating between the digital Rx signal 1941 and the reference sequence may be performed according to a correlation technique, which may support a technical solution to correlate the digital Rx signal 1941 with a relatively long reference sequence, e.g., as described below.

In some demonstrative aspects, correlating between the digital Rx signal 1941 and the reference sequence may be performed utilizing a plurality of computational operations, which may be configured to support reduced computational complexity, e.g., as described below.

In some demonstrative aspects, as indicated at block 1920, the method may include transforming the digital Rx signal 1941 into a frequency-domain Rx signal 1935, for example, by applying an FFT to the digital Rx signal 1941. For example, radar processor 834 (FIG. 8) may receive the digital Rx signal 1941 from receiver 885 (FIG. 8), e.g., as part of radar Rx data 811 (FIG. 1), and may transform the digital Rx signal 1941 into the frequency-domain Rx signal 1935, for example, by applying the FFT to the digital Rx signal 1941.

In some demonstrative aspects, as indicated by arrow 1922, the method may include determining XCORR data 1923 corresponding to a plurality of Doppler values, e.g., M Doppler values, denoted, DopHypo1 . . . DopHypoM. For example, the XCORR data 1923 corresponding to the plurality of Doppler values may be determined, for example, by multiplying the frequency-domain radar Rx signal 1935 by a plurality of coded reference signals corresponding to the plurality of Doppler values, respectively.

For example, as shown in FIG. 19, the method may include multiplying the frequency-domain radar Rx signal 1935 by the plurality of coded reference signals using a plurality of digital matched filters 1938, denoted “Coded-MF DopHypoX”, e.g., wherein X=1 . . . M. For example, the digital matched filters 1938 may be configured according to the reference code 1930.

For example, a digital matched filter Coded-MF DopHypoX corresponding to a particular Doppler value DopHypoX may be configured to generate XCORR data corresponding to the Doppler value DopHypoX, for example, by multiplying the frequency-domain radar Rx signal 1935 by the coded reference signal corresponding to the Doppler value DopHypoX.

For example, radar processor 834 (FIG. 8) may include the plurality of digital matched filters 1938 to multiply the frequency-domain radar Rx signal 1935 by the coded reference signals corresponding to the Doppler values DopHypo1 . . . DopHypoM.

In one example, radar processor 834 (FIG. 8) may utilize a digital matched filter 1938, denoted Coded-MF DopHypo1, to determine XCORR data 1939 corresponding to a Doppler value, denoted DopHypo1, for example, by multiplying the frequency-domain radar Rx signal 1935 by a coded reference signal corresponding to the Doppler value DopHypo1.

In one example, applying the digital matched filters 1938 to multiply the frequency-domain radar Rx signal 1935 by the plurality of coded reference signals may be equivalent, for example, to a convolution of the digital radar Rx signal 1941 with the coded reference signals, e.g., in the time domain.

In some demonstrative aspects, as indicated by arrow 1924, the method may include decimating the XCORR data 1923 into decimated XCORR data 1925. For example, radar processor 834 (FIG. 8) may decimate the XCORR data 1939 into decimated XCORR data 1947.

In some demonstrative aspects, the XCORR data 1923 may be decimated into decimated XCORR data 1925 according to a decimation factor of at least 50.

In some demonstrative aspects, the XCORR data 1923 may be decimated into decimated XCORR data 1925 according to a decimation factor of at least 100.

In some demonstrative aspects, the XCORR data 1923 may be decimated into decimated XCORR data 1925 according to a decimation factor of at least 200.

In some demonstrative aspects, the XCORR data 1923 may be decimated into decimated XCORR data 1925 according to a decimation factor of at least 500.

In other aspects, the XCORR data 1923 may be decimated into decimated XCORR data 1925 according to any other decimation factor.

In some demonstrative aspects, as indicated by arrow 1929, the method may include generating range-Doppler data 1949, for example, by transforming the decimated XCORR data 1947 into the time-domain, for example, by applying an IFFT 1926 to the decimated XCORR data 1947. For example, radar processor 834 (FIG. 8) may apply the IFFT 1926 to the decimated XCORR data 1947, for example, to generate the range-Doppler data 1949.

In some demonstrative aspects, as shown in FIG. 19, the range-Doppler data 1949 may include a plurality of range responses corresponding to the plurality of Doppler values. For example, the range-Doppler data 1949 may include M range responses, denoted h₁(t) . . . h_{M}(t), corresponding to the M Doppler values DopHypo1 . . . DopHypoM, respectively.

In some demonstrative aspects, it may be useful to decimate the XCORR data 1923, e.g., prior to applying the IFFT, for example, as the range response of the radar Rx signal 1941 may be relatively short.

In some demonstrative aspects, decimating the XCORR data prior to applying the IFFT may support, for example, a reduction of the computational complexity of the IFFT.

In one example, decimating the XCORR data 1923 may provide a technical advantage to reduce an overall computational complexity for processing the radar frame.

In one example, a ratio between an FFT size of the FFT, e.g., at block 1920, and an IFFT size of the IFFT 1926, may be based on a decimation factor of the decimated XCORR data 1947 relative to the XCORR data 1923, e.g., before the decimation. For example, decimating the XCORR data 1923 may support using a reduced IFFT size, e.g., corresponding to the decimation factor.

For example, a computational complexity of a full size IFFT without decimation may be determined, e.g., as follows:

M*N*log(N)=N*M*log(N)

wherein N denotes a length of the radar frame, M denotes a number of Doppler hypothesis.

In some demonstrative aspects, a computational complexity of a reduced-size IFFT, example, with decimation, may be determined, e.g., as follows:

M*L*log(L)+M*L*L=M*L*log(L)+M*L*L=N*(log(L)+L)

wherein L denotes a length of a short FFT, e.g., L=N/M, for example, assuming a Low Pass Filter (LPF) length L.

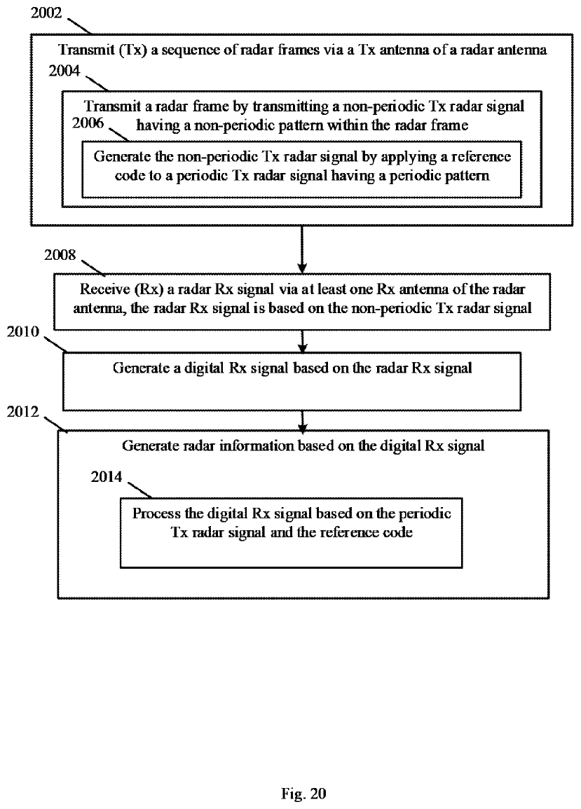

Reference is made to FIG. 20, which schematically illustrates a method of radar processing based on a non-periodic Tx radar signal having a non-periodic pattern, in accordance with some demonstrative aspects. For example, one or more of the operations of the method of FIG. 20 may be performed by a transmitter, e.g., transmitter 883 (FIG. 8), a receiver, e.g., receiver 885 (FIG. 8), and/or a processor, e.g., radar processor 834 (FIG. 8).

As indicated at block 2002, the method may include transmitting a sequence of radar frames via a Tx antenna. For example, radar processor 834 (FIG. 8) may control, cause, trigger, and/or instruct transmitter 883 (FIG. 8) to transmit the sequence of radar frames via Tx antenna 814 (FIG. 8), e.g., as described above.

As indicated at block 2004, transmitting the sequence of radar frames may include transmitting a radar frame by transmitting a non-periodic Tx radar signal having a non-periodic pattern within the radar frame. For example, radar processor 834 (FIG. 8) may control, cause, trigger, and/or instruct transmitter 883 (FIG. 8) to transmit the radar frame, for example, by transmitting the non-periodic Tx radar signal having the non-periodic pattern within the radar frame, e.g., as described above.

As indicated at block 2006, transmitting the non-periodic Tx radar signal may include generating the non-periodic Tx radar signal by applying a reference code to a periodic Tx radar signal having a periodic pattern. For example, radar processor 834 (FIG. 8) may generate the non-periodic Tx radar signal, for example, by applying the reference code to the periodic Tx radar signal having the periodic pattern, e.g., as described above.

As indicated at block 2008, the method may include receiving a radar Rx signal, which is based on the non-periodic Tx radar signal, via at least one Rx antenna. For example, radar processor 834 (FIG. 8) may control, cause, trigger, and/or instruct receiver 885 (FIG. 8) to receive the radar Rx signal via Rx antenna 816 (FIG. 8), e.g., as described above.

As indicated at block 2010, the method may include generating a digital Rx signal, for example, based on the radar Rx signal. For example, radar processor 834 (FIG. 8) may control, cause, trigger and/or instruct receiver 885 (FIG. 8) to generate the digital Rx signal, for example, based on the radar Rx signal, e.g., as described above.

As indicated at block 2012, the method may include generating radar information based on the digital Rx signal. For example, radar processor 834 (FIG. 8) may generate radar information 813 (FIG. 8), for example, based on the digital Rx signal, e.g., as described above.

As indicated at block 2014, generating the radar information may include processing the digital Rx signal based on the periodic Tx radar signal and the reference code. For example, radar processor 834 (FIG. 8) may process the digital Rx signal based on the periodic Tx radar signal and the reference code, e.g., as described above.

Referring back to FIG. 8, in some demonstrative aspects, radar processor 834 may configure radar frontend 804 to communicate radar frames according to a radar transmission scheme, which may be configured to mitigate, or even prevent, an inter-frame replay attack between transmitted radar frames, e.g., as described below.

In some demonstrative aspects, radar processor 834 may configure radar frontend 804 to communicate radar frames according to a radar transmission scheme, which may be configured for transmission of a radar frame from a plurality of Tx antennas to a plurality of Rx antennas, e.g., as described below.

In some demonstrative aspects, radar processor 834 may configure radar frontend 804 to communicate radar frames according to a radar transmission scheme, which may be configured for communication of a radar frame via a MIMO antenna, by transmitting the radar frame from a plurality of Tx antennas of the MIMO antenna to a plurality of Rx antennas of the MIMO antenna, e.g., as described below.

For example, in a MIMO radar implementation, an orthogonality between Tx signals among different Tx antennas may be achieved, for example, by shifting basic signal samples in time. However, this type of shifting may be used by an attacker, for example, to manipulate angular information, which may be calculated by the radar system.

In one example, a MIMO imaging radar may include a large number of Tx antennas and/or a large number of Rx antennas. According to this example, in order to be able to spoof a radar frame, an attacker may need to be able to reproduce all the signals from all the transmitting antennas. For example, the attacker may need to know which antenna transmitted which signal, e.g., in order to create a specific ghost target.

In some demonstrative aspects, radar processor 834 may configure radar frontend 804 to communicate radar frames according to a radar transmission scheme, which may be configured to mitigate, or even prevent, spoofing attacks, for example, while maintaining periodicity of the transmitted radar signals, e.g., as described below.

In some demonstrative aspects, radar processor 834 may configure radar frontend 804 to communicate radar frames according to a radar transmission scheme, which may be configured to code signals transmitted via an antenna, e.g., via each antenna, in a non-periodic manner, e.g., as described below.

For example, by coding the signals transmitted via an antenna in a non-periodic manner, an attacker may not be able to use a first signal transmitted via the antenna in order to predict a second, subsequent, signal to be transmitted via the antenna. Accordingly, an attacker may not be able to coordinate an attack to spoof a target, e.g., in a way which will be coherent after signals from all the antennas are combined.

In some demonstrative aspects, radar processor 834 may configure radar frontend 804 to communicate radar frames according to a radar transmission scheme, which may be configured to code frames, e.g., each frame, differently. For example, a frame, e.g., each frame, of a MIMO transmission may be independent on a previous frame. According to these aspects, the different coding of the frames may prevent an attacker from learning from one frame on a next frame.

In some demonstrative aspects, the radar transmission scheme may be configured to change, e.g., in a random manner, an association between a Tx radar signal and a Tx antenna 814, for example, between radar frames. As a result, the attacker may not be able to learn a signal-to antenna mapping to be used for a next frame.

In some demonstrative aspects, the radar transmission scheme may be configured to code a mapping between the Tx antennas and a transmit carrier frequency, e.g., according to a frequency hopping scheme, for example, in addition to, or instead of, the coding of the mapping between the Tx antennas and the Tx signals.

In some demonstrative aspects, radar processor 834 may be configured to control, cause, trigger, and/or instruct transmitter 883 to transmit a plurality of radar frames via the plurality of Tx antennas 814, e.g., as described below.

In some demonstrative aspects, radar processor 834 may be configured to control, cause, trigger, and/or instruct transmitter 883 to transmit the plurality of radar frames, for example, by transmitting a plurality of Tx radar signals via the plurality of Tx antennas 814 according to a non-periodic mapping scheme including a non-periodic sequence of mappings, e.g., as described below.

In some demonstrative aspects, the non-periodic sequence of mappings may include a random sequence of mappings, e.g., as described below.

In other aspects, any other non-periodic sequence of mappings may be implemented.

In some demonstrative aspects, radar processor 834 may be configured to control, cause, trigger, and/or instruct transmitter 883 to transmit a radar frame of the plurality of radar frames, for example, by transmitting the plurality of Tx radar signals via the plurality of Tx antennas 814 according to a mapping of the non-periodic sequence of mappings, e.g., as described below.

In some demonstrative aspects, radar processor 834 may be configured to control, cause, trigger, and/or instruct receiver 885 to receive a plurality of radar Rx signals via the plurality of Rx antennas, e.g., as described below.

In some demonstrative aspects, the radar Rx signals may be based on the plurality of Tx radar signals transmitted from transmitter 883.

In some demonstrative aspects, radar processor 834 may be configured to generate radar information 813, for example, based on the radar Rx signals, e.g., as described below.

In some demonstrative aspects, radar processor 834 may be configured to process the plurality of radar Rx signals, for example, based on the non-periodic mapping scheme, e.g., as described below.

In some demonstrative aspects, radar processor 834 may configure the transmitter 883 to transmit a first radar frame of the plurality of radar frames, for example, by mapping the plurality of Tx radar signals to the plurality of Tx antennas 814 according to a first mapping of the non-periodic sequence of mappings.

In some demonstrative aspects, radar processor 834 may be configured to configure the transmitter 883 to transmit a second radar frame, for example, by mapping the plurality of Tx radar signals to the plurality of Tx antennas 814 according to a second mapping of the non-periodic sequence of mappings.

In some demonstrative aspects, the second mapping of the non-periodic sequence of mappings may be different from the first mapping of the non-periodic sequence of mappings.

In some demonstrative aspects, the plurality of Tx radar signals may include, for example, a plurality of periodic Tx radar signals. For example, a periodic Tx radar signal may have a periodic pattern within the radar frame.

In some demonstrative aspects, the plurality of Tx radar signals may include, for example, a plurality of chirp signals.

In some demonstrative aspects, the plurality of Tx radar signals may include, for example, a plurality of non-periodic Tx radar signals having a non-periodic pattern within the radar frame.

In one example, a non-periodic Tx radar signal having the non-periodic pattern within the radar frame may include a periodic Tx radar signal multiplied by a reference code, e.g., as described above.

In other aspects, the plurality of Tx radar signals may include any other signals.

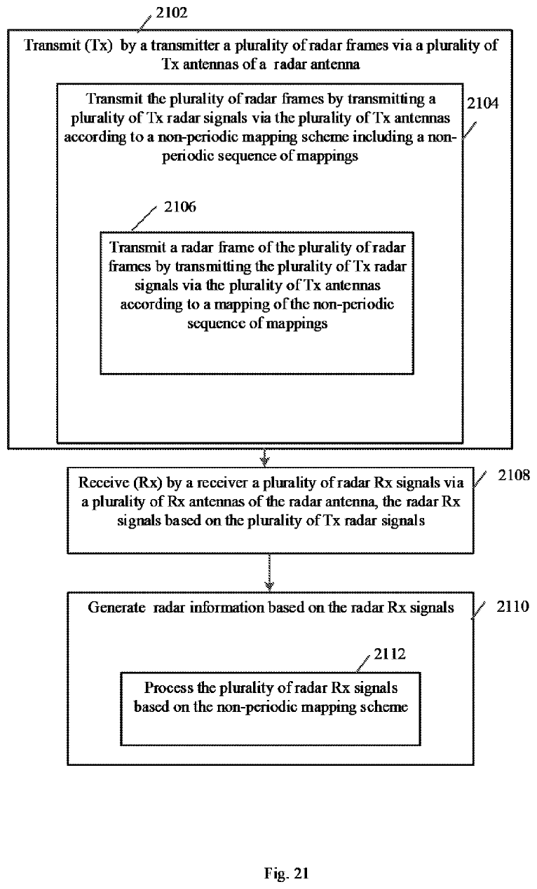

Reference is made to FIG. 21, which schematically illustrates a method of radar processing based on Tx radar signals transmitted via a plurality of Tx antennas according to a non-periodic mapping scheme, in accordance with some demonstrative aspects. For example, one or more of the operations of the method of FIG. 21 may be performed by a transmitter, e.g., transmitter 883 (FIG. 8), a receiver, e.g., receiver 885 (FIG. 8), and/or a processor, e.g., radar processor 834 (FIG. 8).

As indicated at block 2102, the method may include transmitting a plurality of radar frames via plurality of Tx antennas. For example, radar processor 834 (FIG. 8) may control, cause, trigger, and/or instruct transmitter 883 (FIG. 8) to transmit the plurality of radar frames via the plurality of Tx antennas 814 (FIG. 8), e.g., as described above.

As indicated at block 2104, transmitting the plurality of radar frames may include transmitting a plurality of Tx radar signals via the plurality of Tx antennas according to a non-periodic mapping scheme including a non-periodic sequence of mappings. For example, radar processor 834 (FIG. 8) may control, cause, trigger, and/or instruct transmitter 883 (FIG. 8) to transmit the plurality of Tx radar signals via the plurality of Tx antennas according to the non-periodic mapping scheme, e.g., as described above.

As indicated at block 2106, transmitting the plurality of Tx radar signals via the plurality of Tx antennas may include transmitting a radar frame of the plurality of radar frames by transmitting the plurality of Tx radar signals via the plurality of Tx antennas according to a mapping of the non-periodic sequence of mappings. For example, radar processor 834 (FIG. 8) may control, cause, trigger, and/or instruct transmitter 883 (FIG. 8) to transmit the radar frame of the plurality of radar frames, for example, by transmitting the plurality of Tx radar signals via the plurality of Tx antennas 814 (FIG. 8) according to a mapping of the non-periodic sequence of mappings, e.g., as described above.

As indicated at block 2108, the method may include receiving a plurality of radar Rx signals via a plurality of Rx antennas, the radar Rx signals based on the plurality of Tx radar signals. For example, radar processor 834 may control, cause, trigger, and/or instruct receiver 885 (FIG. 8) to receive the plurality of radar Rx signals via the plurality of Rx antennas 816 (FIG. 8), based on the plurality of Tx radar signals transmitted via Tx antennas 814 (FIG. 8), e.g., as described above.

As indicated at block 2110, the method may include generating radar information based on the radar Rx signals. For example, radar processor 834 (FIG. 8) may generate radar information 813 (FIG. 8) based on the radar Rx signals of radar Rx data 811 (FIG. 8), e.g., as described above.

As indicated at block 2112, generating the radar information may include processing the plurality of radar Rx signals based on the non-periodic mapping scheme. For example, radar processor 834 (FIG. 8) may process the plurality of radar Rx signals based on the non-periodic mapping scheme, e.g., as described above.

Referring to FIG. 8, in some demonstrative aspects, radar frontend 804 and/or MIMO radar antenna 881, may be configured to operate, for example, in various environmental conditions, for example, weather conditions or any other natural and/or artificial environmental conditions, e.g., as described below.

In some demonstrative aspects, there may be a need to provide a technical solution to support proper operation of radar frontend 804 and/or MIMO radar antenna 881, for example, in various environmental conditions, e.g., weather conditions, e.g., as described below.

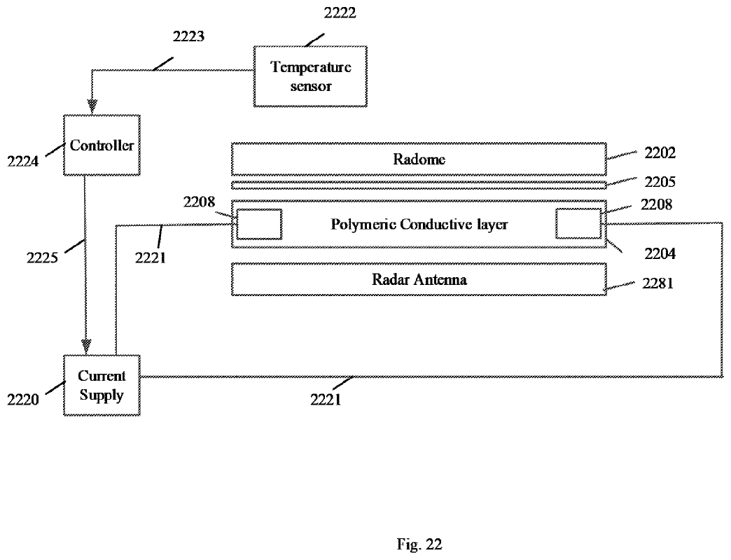

Reference is made to FIG. 22, which schematically illustrates a radar radome apparatus 2200 configured to protect a radar antenna 2281, in accordance with some demonstrative aspects. For example, radar frontend 804 (FIG. 8) may include one or more elements of apparatus 2200, for example, to protect MIMO radar antenna 881 (FIG. 8), e.g., as described below.

In some demonstrative aspects, apparatus 2200 may be configured to support proper operation of radar antenna 2281, e.g., MIMO radar antenna 881 (FIG. 8), for example, in various environmental conditions, e.g., weather conditions, as described below.

In some demonstrative aspects, apparatus 2200 may include a radome 2202 configured to cover radar antenna 2281. For example, radome 2202 may be configured to cover radar antenna 881 (FIG. 8).

In some demonstrative aspects, radome 2202 may be configured to protect the radar antenna 2281, for example, in one or more scenarios and/or use cases, for example, in various whether conditions, e.g., as descried below.

In some demonstrative aspects, the radome 2202 may be configured, for example, to protect a front surface of the MIMO radar antenna 2281, for example, from rain, snow, hail, icing, humidity, fog, and/or any other additional or alternative weather condition and/or environmental condition.

In some demonstrative aspects, apparatus 2200 may be configured to prevent accumulation of one or more substances on radome 2202, for example, to enable proper and/or safe performance of a radar frontend, e.g., radar frontend 804 (FIG. 8), utilizing the radar antenna 2281, e.g., as described below.

In some demonstrative aspects, apparatus 2200 may be configured to remove, defrost, and/or de-ice one or more substances, for example, precipitation substances, e.g., snow, ice, rain, hail or the like, from the radome 2202, e.g., as described below.

In some demonstrative aspects, apparatus 2200 may be configured to remove, defrost, and/or de-ice the one or more substances, for example, by heating one or more parts of radome 2202, e.g., as described below.

In some demonstrative aspects, in some use cases and/or implementations there may be one or more disadvantages, inefficiencies, and/or technical problems in an implantation for deicing a radome using metal strips spread along the radome to heat the radome, e.g., when an electric current flows through the metal strips.

For example, the metal strips may not be suitable for deicing a radome covering a radar antenna, for example, since the metal strips may cause surface currents effects, for example, which may distort radar Tx signals transmitted from the radar antenna and/or radar Rx signals received by the radar antenna.

For example, the metal strips on the radome may cause wave surface distortion, which may have an impact on performance accuracy of the radar antenna. For example, it may be difficult to mitigate the wave surface distortion, for example, as correction factors to mitigate this distortion may not be constant, e.g., may vary with aging.

In some demonstrative aspects, apparatus 2200 may be configured to protect radar antenna 2281, for example, by implementing a de-icing mechanism, which may allow defrosting and/or deicing the radome 2201, for example, while avoiding the wave surface distortion effects, e.g., as described below.

In some demonstrative aspects, apparatus 2200 may include a polymeric conductive layer 2204 bonded to the radome 2202, e.g., as described below.

In some demonstrative aspects, the polymeric conductive layer 2204 may be configured to heat the radome 2202, for example, when the polymeric conductive layer 2204, is subject to an electrical current 2221, e.g., as described below.

In some demonstrative aspects, apparatus 2200 may include a plurality of electrical contacts 2208 to electrically connect the polymeric conductive layer 2204 to a current supply 2220, for example, to drive the electrical current 2221 via the polymeric conductive layer 2204, e.g., as described below.

In one example, the plurality of electrical contacts 2208 may include at least two electrical contacts. For example, the plurality of electrical contacts 2208 may include at least one electrical contact 2208 on each side of the polymeric conductive layer 2204.

In another example, any other number of electrical contacts 2208 may be implemented at any other position and/or location.

In some demonstrative aspects, as shown in FIG. 22, the polymeric conductive layer 2204 may be bonded to a backside of the radome 2202 facing the radar antenna 2281, e.g., as described below.

In some demonstrative aspects, as shown in FIG. 22, the polymeric conductive layer 2204 may be between the radome 2202 and the radar antenna 2281, e.g., as described below.

In some demonstrative aspects, as shown in FIG. 22, the polymeric conductive layer may be configured to cover a region of the radome 2202 covering the radar antenna 2281, e.g., as described below.

In some demonstrative aspects, the polymeric conductive layer 2204 may include a carbon-based filler, e.g., as described below.

some demonstrative aspects, the carbon-based filler may include carbon fibers, a Carbon Nanotube (CNT), graphite, black carbon, and/or any other carbon based filler, e.g., as described below.

In some demonstrative aspects, the polymeric conductive layer 2204 may include a printed conductive ink layer, e.g., as described below.

In some demonstrative aspects, the polymeric conductive layer 2204 may include an overmolded polymeric conductive layer, e.g., as described below.

In some demonstrative aspects, the polymeric conductive layer 2204 may include an injected molded polymeric conductive layer, e.g., as described below.

In other aspects, the polymeric conductive layer 2204 may include any other additional or alternative type and/or configuration of a polymeric conductive material.

In some demonstrative aspects, apparatus 2200 may include a diffusion-bonding layer 2205 configured to bond the polymeric conductive layer 2204 to the radome 2202, e.g., as described below.

In some demonstrative aspects, the plurality of electrical contacts 2208 may include a plurality of Three-Dimensional Molded Interconnect Devices (3D-MID) electrical contacts, e.g., as described below.

In some demonstrative aspects, the plurality of electrical contacts 2208 may include a plurality of conductive adhesive contacts, e.g., as described below.

In some demonstrative aspects, the plurality of electrical contacts 2208 may include a plurality of Two-Dimensional (2D) electrical contacts, e.g., as described below.

In other aspects, the plurality of electrical contacts 2208 may include any other additional or alternative type and/or configuration of electrical contacts.

In some demonstrative aspects, apparatus 2200 may include a temperature sensor 2222 configured to sense a temperature of the radome 2202, e.g., as described below.

In some demonstrative aspects, temperature sensor 2222 may be mounted over radome 2202, e.g., over a thermal conductive zone of radome 2202. In other aspects, temperature sensor 2222 may be placed on, or near radome 2202, and/or connected to radome 2202, at any other location.

In some demonstrative aspects, apparatus 2200 may include a controller 2224 configured to control, e.g., using a control signal 2225, the current supply 2220 to drive the current 2221 via the polymeric conductive layer 2204 based, for example, on the temperature of the radome 2202, e.g., as described below.

In some demonstrative aspects, controller 2224 may receive from temperature sensor 2222 an input 2223 indicating a sensed temperature of radome 2202. For example, controller 2224 may be configured to control the current 2221 to be provided by the current supply 2220 based on the input 2223.

In some demonstrative aspects, one or more functionalities and/or operations of controller 2224 may be implemented as part of one or more elements of radar frontend, e.g., radar frontend 804 (FIG. 8).

In one example, one or more functionalities and/or operations of controller 2224 may be implemented as part of a radar processor, e.g., radar processor 834 (FIG. 8).

In other aspects, one or more functionalities of controller 2224 may be implemented by one or more other elements of a radar device, e.g., radar device 101 (FIG. 1), for example, by one or more dedicated and/or separate elements, which may be separate from radar frontend 804 (FIG. 8).

In some demonstrative aspects, apparatus 2200 may be implemented to provide one or more technical advantages and/or solutions, for example, to efficiently protect radar antenna 2281, for example, while avoiding or reducing potential distortion of signals communicated by the radar antenna 2281.

In one example, the polymeric conductive layer 2204 may be implemented to provide a technical solution to heat the radome 2202, for example, while avoiding the use of metallic materials. Accordingly, the polymeric conductive layer 2204 may be implemented to provide a technical solution to heat the radome 2202, in a manner, which may maintain accurate performance of radar antenna 2281.

In another example, the polymeric conductive layer 2204 may be implemented to provide a technical solution to heat the radome 2202, for example, with a high level of stability and/or reliability. For example, the polymeric conductive layer 2204 may be implemented to avoid the deficiencies of metallic materials, for example, effects of metal strip movement and/or distortion due to thermal aging.

In another example, the polymeric conductive layer 2204 may be implemented to provide a technical solution to heat the radome 2202, for example, with a reduced cost, e.g., compared to a cost of an implementation using metallic strips.

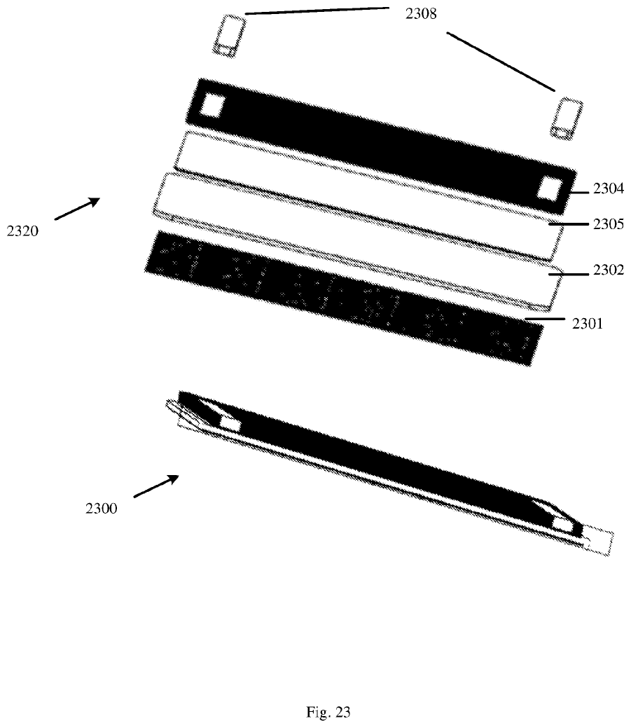

Reference is made to FIG. 23, which schematically illustrates a cross section view of a radar radome apparatus 2300, and an exploded view 2320 of the radar radome apparatus 2300, in accordance with some demonstrative aspects. For example, radar radome apparatus 2200 (FIG. 22) may include one or more elements of radar radome apparatus 2300.

In some demonstrative aspects, as shown in FIG. 23, apparatus 2300 may include a radome 2302 configured to cover a radar antenna, e.g., radar antenna 881 (FIG. 8).

In some demonstrative aspects, as shown in FIG. 23, radome 2302 may be configured to defrost and/or remove a layer 2301 of a substance, which may cover at least part of radome 2302. For example, the layer 2301 may include a layer of snow, ice, hail, humidity, fog, or the like.

In some demonstrative aspects, as shown in FIG. 23, apparatus 2300 may include a polymeric conductive layer 2304 configured to heat the radome 2302, for example, when the polymeric conductive layer 2304, is subject to an electrical current.

In some demonstrative aspects, as shown in FIG. 23, apparatus 2300 may include a plurality of electrical contacts 2308 to electrically connect the polymeric conductive layer 2304 to a current supply, e.g., current supply 2220 (FIG. 22), for example, to drive the electrical current via the polymeric conductive layer 2304.

In some demonstrative aspects, polymeric conductive layer 2304 may be connected to radome 2302, for example, by an adhesion layer.

In some demonstrative aspects, apparatus 2300 may include a diffusion-bonding layer 2305 configured to bond the polymeric conductive layer 2304 to the radome 2302.

In some demonstrative aspects, polymeric conductive layer 2304 may be attached to a backside of radome 2302, for example, by diffusion or any other process, which may form diffusion-bonding layer 2305.

In some demonstrative aspects, polymeric conductive layer 2304 may include a carbon based filler, e.g., including CNT Graphite, Carbon fibers, black carbon, and/or any other type of carbon-based filler.

In some demonstrative aspects, the plurality of electrical contacts 2308 may be over polymeric conductive layer 2304. For example, the plurality of electrical contacts 2308 may include 3D-MID contacts and/or any other type of metal contacts and/or pads.

In some demonstrative aspects, polymeric conductive layer 2304 may generate heat, for example, in response to a current flow between electrical contacts 2308 via polymeric conductive layer 2304.

In some demonstrative aspects, the generated heat may be conducted directly to the radome 2302, e.g., thermodynamically.

In some demonstrative aspects, apparatus 2300 may be produced and/or assembled, for example, using two polymers. For example, apparatus 2300 may be produced using radome 2302 and polymeric conductive layer 2304.

In one example, radome 2302 may be formed of a polymer for mmWave transparency, and/or polymeric conductive layer 2304 may include a conductive polymer layer bonded to radome 2302, for example, by diffusion-bonding layer

In some demonstrative aspects, polymeric conductive layer 2304 may be produced and/or assembled with radome 2302, for example, using an over molding process, a 2K injection molding process, and/or any other molding process.

In some demonstrative aspects, polymeric conductive layer 2304 may be produced and/or assembled with radome 2302, for example, using printed conductive inks.

In other aspects, polymeric conductive layer 2304 may be produced and/or assembled with radome 2302, for example, using any other materials and/production processes.

In some demonstrative aspects, the plurality of electrical contacts 2308 may be configured to electrically connect the polymeric conductive layer 2304 to between a radar main board, e.g., which may support current supply 2220 (FIG. 22) and/or controller 2224 (FIG. 22).

In some demonstrative aspects, the plurality of electrical contacts 2308 may be produced by a 3D-MID production process, usage of conductive adhesive, conductive Pressure Sensitive Adhesive, a conductive metal deposition, and/or any other additional or alternative production process.

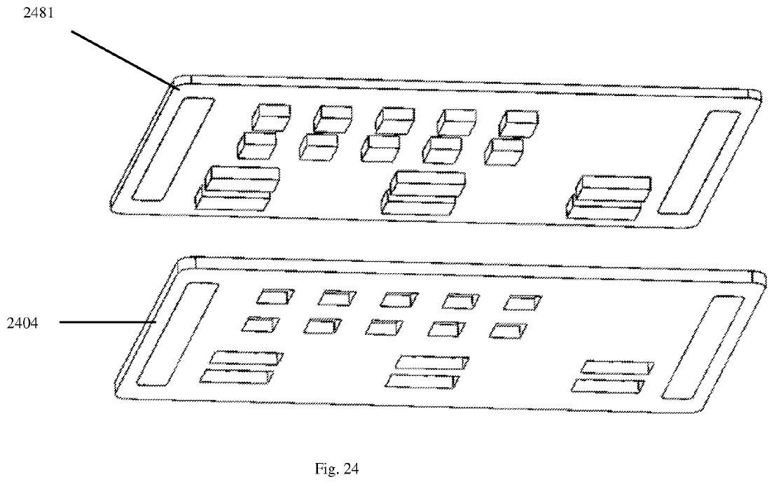

Reference is made to FIG. 24, which schematically illustrates an exploded view of a polymeric conductive layer 2404 to protect a radar antenna 2481, in accordance with some demonstrative aspects. For example, polymeric conductive layer 2204 (FIG. 22) and/or polymeric conductive layer 2304 (FIG. 23) may include one or more elements of polymeric conductive layer 2404.

In some demonstrative aspects, as shown in FIG. 24, polymeric conductive layer 2404 may be configured to match a layout of radar antenna 2481.

In some demonstrative aspects, as shown in FIG. 24, polymeric conductive layer 2404 may be configured to cover, e.g., to partially or even fully cover, a surface of radar antenna 2481.

In some demonstrative aspects, as shown in FIG. 24, polymeric conductive layer 2404 may be configured to include notches or holes, which may match antenna locations of antenna elements of radar antenna 2481.

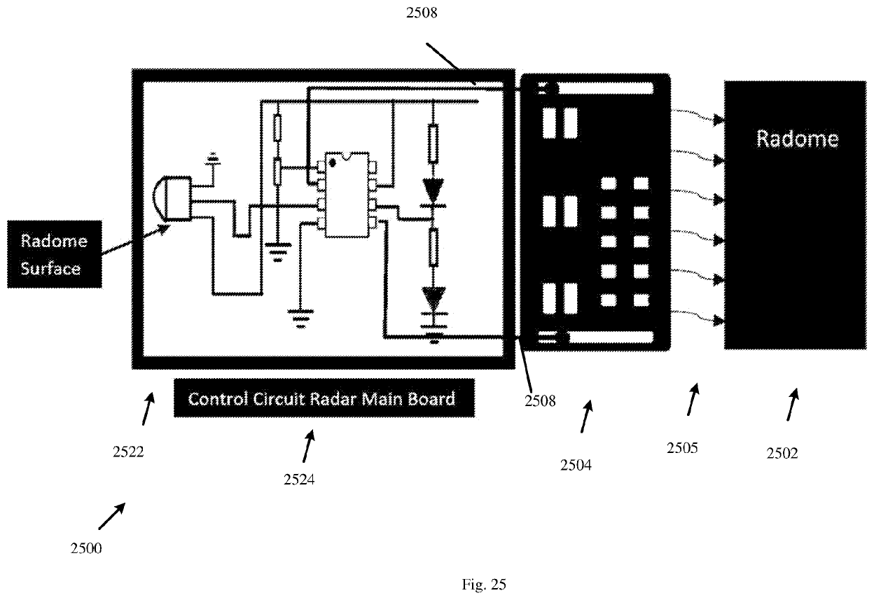

Reference is made to FIG. 25, which schematically illustrates a radar radome apparatus 2500, in accordance with some demonstrative aspects. For example, radar radome apparatus 2200 (FIG. 22) may include one or more elements of radar radome apparatus 2500.

In some demonstrative aspects, as shown in FIG. 25, radar radome apparatus 2500 may include a temperature sensor 2522 configured to sense a temperature on a surface of a radome 2502. For example, temperature sensor 2222 (FIG. 22) may include one or more elements of temperature sensor 2522, and/or may perform one or more operations of, and/or one or more functionalities of, temperature sensor 2522; and/or radome 2502 may include radome 2302 (FIG. 23).

In one example, temperature sensor 2522 may include a thermistor, which may be mounted, for example, on a thermal conductive zone of radome 2502.

In some demonstrative aspects, as shown in FIG. 25, radar radome apparatus 2500 may include a polymeric conductive layer 2504 configured to heat the radome 2502, for example, when the polymeric conductive layer is subject to an electrical current, which may be provided via electrical contacts 2508

In some demonstrative aspects, as shown in FIG. 25, radar radome apparatus 2500 may include control circuitry 2524 configured to control the electrical current via the polymeric conductive layer 2504, for example, based on the temperature sensed by the temperature sensor 2522. For example, controller 2224 (FIG. 22) may control circuitry 2524, and/or may perform one or more operations of, and/or one or more functionalities of, control circuitry 2524.

In one example, control circuitry 2524 may be implemented on a main board of a radar frontend, e.g., radar frontend 804 (FIG. 8).

In some demonstrative aspects, control circuitry 2524 may be configured to activate the current flow via polymeric conductive layer 2504 to heat (2505) the radome 2502, for example, when temperature sensor 2522 senses a temperature below a predefined temperature threshold, e.g., a temperature close to or below 0° C., or any other temperature.

In some demonstrative aspects, control circuitry 2524 may be configured to deactivate the current flow via polymeric conductive layer 2504, e.g., to stop heating radome 2502, for example, when temperature sensor 2522 senses a temperature above the temperature threshold, e.g., above 0° C.

In some demonstrative aspects, control circuitry 2524 and/or a radar processor, e.g., radar processor 834 (FIG. 8), may be configured to detect and/or report one or more malfunction events of radar radome apparatus 2500, for example, according to a Functional Safety (FuSa) standard and/or protocol, e.g., as described below.

In some demonstrative aspects, control circuitry 2524 may be configured to detect a malfunction event of radar radome apparatus 2500, for example, based on the current flow via polymeric conductive layer 2504. For example, control circuitry 2524 may be configured to monitor the current flow via polymeric conductive layer 2504, and may detect a malfunctioning of radar radome apparatus 2500, for example, based on a determination that the current flow via polymeric conductive layer 2504 is too low, e.g., below a predefined threshold, or too high, e.g., above a predefined threshold.

In some demonstrative aspects, control circuitry 2524 may be configured to detect a malfunction event of radar radome apparatus 2500, for example, based on the temperature sensed by temperature sensor 2522. For example, control circuitry 2524 may be configured to monitor the temperature sensed by temperature sensor 2522, and may detect a malfunctioning of radar radome apparatus 2500, for example, based on a determination that the temperature sensed by temperature sensor 2522 is too low, e.g., below a predefined threshold, or too high, e.g., above a predefined threshold.

In some demonstrative aspects, a radar processor, e.g., radar processor 834 (FIG. 8), may be configured to detect a malfunction event of radar radome apparatus 2500, for example, based on radar information, e.g., radar information 813 (FIG. 8), generated based on the radar signals communicated by a radar frontend, e.g., radar frontend 804 (FIG. 8). For example, radar processor 834 may be configured to analyze the radar information 813 (FIG. 8) to detect erroneous data, which may indicate a malfunctioning of radar radome apparatus 2500. In one example, radar processor 834 may be configured to analyze 4D point cloud data in radar information 813 (FIG. 8), for example, to identify erroneous 4D data, which may indicate a malfunctioning of radar radome apparatus 2500.

In some demonstrative aspects, radar processor 834 (FIG. 8) and/or control circuitry 2524 may be configured to report a detected malfunctioning event of radar radome apparatus 2500 to a higher layer, for example, to a system controller, e.g., vehicle controller 108 (FIG. 1), or to system controller 310 (FIG. 3).

In some demonstrative aspects, control circuitry 2524 may be configured to provide to radar processor 834 (FIG. 8) a malfunction indication signal to indicate malfunction of radar radome apparatus 2500, e.g., in the form of an error signal, a malfunction signal, or an alarm signal.

In some demonstrative aspects, radar processor 834 (FIG. 8) may be configured to provide to the system controller, e.g., to vehicle controller 108 (FIG. 1), or to system controller 310 (FIG. 3), a malfunction indication signal to indicate malfunction of radar radome apparatus 2500, e.g., in the form of an error signal, a malfunction signal, or an alarm signal.

In one example, radar processor 834 (FIG. 8) may be configured to provide the malfunction indication signal to the system controller, for example, based on the malfunction indication signal from control circuitry 2524.

In another example, radar processor 834 (FIG. 8) may be configured to provide the malfunction indication signal to the system controller, for example, based on a malfunction event of radar radome apparatus 2500, which is detected by radar processor 834 (FIG. 8) based on the radar information 813 (FIG. 8).

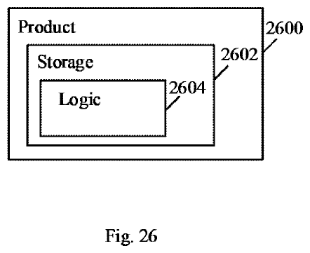

Reference is made to FIG. 26, which schematically illustrates a product of manufacture 2600, in accordance with some demonstrative aspects. Product 2600 may include one or more tangible computer-readable (“machine-readable”) non-transitory storage media 2602, which may include computer-executable instructions, e.g., implemented by logic 2604, operable to, when executed by at least one computer processor, enable the at least one computer processor to implement one or more operations and/or functionalities described with reference to the FIGS. 1-25, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2600 and/or storage media 2602 may include one or more types of computer-readable storage media capable of storing data, including volatile memory, non-volatile memory, removable or non-removable memory, erasable or non-erasable memory, writeable or re-writeable memory, and the like. For example, storage media 2602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2604 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further aspects.

Example 1 includes an apparatus comprising a first radar comprising a first plurality of Transmit (Tx) antennas and a first plurality of Receive (Rx) antennas, the first radar configured to communicate radar signals in a first radar Field Of View (FOV); a second radar comprising a second plurality of Tx antennas and a second plurality of Rx antennas, the second radar configured to communicate radar signals in a second radar FOV, wherein the first and second radar FOVs partially overlap; and a processor configured to determine radar synchronization information to synchronize between the first and second radars, the processor configured to generate radar information corresponding to a target based on the radar synchronization information, a Tx radar signal transmitted by the first radar, a first Rx signal received by the first radar based on the Tx radar signal, and a second Rx signal received by the second radar based on the Tx radar signal.

Example 2 includes the subject matter of Example 1, and optionally, wherein the processor is configured to determine the radar information corresponding to the target based on a plurality of Radar Cross Section (RCS) estimations, the plurality of RCS estimations comprising a first RCS estimation and a second RCS estimation, wherein the first RCS estimation is based on the Tx radar signal transmitted by the first radar and the first Rx signal received by the first radar based on the Tx radar signal, wherein the second RCS estimation is based on the Tx radar signal transmitted by the first radar and the second Rx signal received by the second radar based on the Tx radar signal.

Example 3 includes the subject matter of Example 2, and optionally, wherein the plurality of RCS estimations comprises a third RCS estimation and a fourth RCS estimation, wherein the third RCS estimation is based on an other Tx radar signal transmitted by the second radar and a third Rx signal received by the second radar based on the other Tx radar signal, wherein the fourth RCS estimation is based on the other Tx radar signal transmitted by the second radar and a fourth Rx signal received by the first radar based on the other Tx radar signal.

Example 4 includes the subject matter of any one of Examples 1-3, and optionally, wherein the processor is configured to determine the radar information corresponding to the target according to a super-resolution algorithm based on a plurality of snapshots, the plurality of snapshots comprising a first snapshot and a second snapshot, wherein the first snapshot is based on the Tx radar signal transmitted by the first radar and the first Rx signal received by the first radar based on the Tx radar signal, wherein the second snapshot is based on the Tx radar signal transmitted by the first radar and the second Rx signal received by the second radar based on the Tx radar signal.

Example 5 includes the subject matter of any one of Examples 1-4, and optionally, wherein the processor is configured to identify a ghost target in a multipath scenario based on the second Rx signal received by the second radar, and to generate the radar information based on identification of the ghost target.

Example 6 includes the subject matter of Example 5, and optionally, wherein the processor is configured to identify the ghost target based on detection of an appearance of the ghost target in a first radar path and detection of disappearance of the ghost target in a second radar path, wherein the first radar path comprises the Tx radar signal from the first radar and the second Rx signal received by the second radar based on the Tx radar signal from the first radar, wherein the second radar path comprises an other Tx radar signal from the second radar and an other Rx signal received by the first radar based on the other Tx radar signal from the second radar.

Example 7 includes the subject matter of Example 5 or 6, and optionally, wherein the processor is configured to identify the ghost target based on detection of an appearance of the ghost target in a first radar path and detection of disappearance of the ghost target in a second radar path, wherein the first radar path comprises a first Tx radar signal from the first radar to a first target, a first scattered signal from the first target, a first reflected signal reflected from a second target back to the first target, and a second reflected signal reflected back from the first target to the first radar, wherein the second radar path comprises a second Tx radar signal from the second radar to the second target, a second scattered signal from the second target, a third reflected signal reflected from the first target back to the second target, and a fourth reflected signal reflected back from the second target to the second radar.

Example 8 includes the subject matter of any one of Examples 1-7, and optionally, wherein the processor is configured to determine the radar synchronization information based on timing information broadcasted via the first radar and received via the second radar.

Example 9 includes the subject matter of any one of Examples 1-8, and optionally, wherein the processor is configured to determine the radar information corresponding to the target based on shared radar information broadcasted via the first radar and received via the second radar.

Example 10 includes the subject matter of any one of Examples 1-9, and optionally, wherein the processor is configured to determine the radar synchronization information to synchronize between the first and second radars at an accuracy of up to 1 nanosecond.

Example 11 includes the subject matter of any one of Examples 1-10, and optionally, comprising a vehicle, the vehicle comprising a plurality of radars comprising the first and second radars, the plurality of radars configured to cover a respective plurality of FOVs.

Example 12 includes the subject matter of Example 11, and optionally, wherein a combination of the plurality of FOVs covers a FOV of 360 degrees around the vehicle.

Example 13 includes the subject matter of Example 11 or 12, and optionally, wherein the plurality of radars comprises at least 6 radars.

Example 14 includes the subject matter of any one of Examples 1-13, and optionally, comprising a vehicle, the vehicle comprising a system controller to control one or more systems of the vehicle based on the radar information.

Example 15 includes an apparatus comprising a first radar front-end comprising a plurality of Transmit (Tx) antennas and a Tx synchronization antenna, the plurality of Tx antennas configured to transmit a Tx radar signal towards a target detection direction, the Tx synchronization antenna configured to transmit the Tx radar signal over a synchronization channel; and a second radar front-end comprising a plurality of Receive (Rx) antennas, an Rx synchronization antenna, and a synchronization detector, the plurality of Rx antennas configured to receive an Rx radar signal based on the Tx radar signal transmitted by the plurality of Tx antennas, the Rx synchronization antenna configured to receive the Tx radar signal from the Tx synchronization antenna via the synchronization channel, the synchronization detector configured to determine synchronization information based on the Tx radar signal from the Tx synchronization antenna, wherein the second radar front-end is configured to output the synchronization information and Rx radar data based on the Rx radar signal.

In one example, the apparatus of Example 15 may include, for example, one or more additional elements, and/or may perform one or more additional operations and/or functionalities, for example, as described with respect to Examples 1, 30, 45 and/or 54.

Example 16 includes the subject matter of Example 15, and optionally, comprising a physical channel configured to transfer the radar Tx signal via the synchronization channel in a path between the Tx synchronization antenna and the Rx synchronization antenna.

Example 17 includes the subject matter of Example 16, and optionally, comprising one or more isolated cylinders configured to tunnel the Tx radar signal via the path between the Tx synchronization antenna and the Rx synchronization antenna.

Example 18 includes the subject matter of Example 16 or 17, and optionally, comprising a tunneling film configured to tunnel the Tx radar signal via the path between the Tx synchronization antenna and the Rx synchronization antenna.

Example 19 includes the subject matter of any one of Examples 16-18, and optionally, comprising a flexible Printed Circuit Board (PCB) configured to tunnel the Tx radar signal via the path between the Tx synchronization antenna and the Rx synchronization antenna.

Example 20 includes the subject matter of any one of Examples 16-19, and optionally, comprising an insulation coating on one or more surfaces along the path between the Tx synchronization antenna and the Rx synchronization antenna, the insulation coating configured to tunnel the Tx radar signal via the path between the Tx synchronization antenna and the Rx synchronization antenna.

Example 21 includes the subject matter of any one of Examples 15-6, and optionally, wherein the physical channel is configured to isolate the Tx radar signal from the Tx radar signal transmitted by the plurality of Tx antennas.

Example 22 includes the subject matter of any one of Examples 15-21, and optionally, wherein the synchronization detector is configured to determine the synchronization information based on a time difference between a first timing and a second timing, the first timing comprising a timing of receipt of the Tx radar signal from the Tx synchronization antenna at the Rx synchronization antenna, the second timing comprising a time of a clock of the second radar front-end.

Example 23 includes the subject matter of Example 15-22, and optionally, wherein the synchronization detector is configured to determine the synchronization information based on a path delay of the Tx radar signal in a path between the Tx synchronization antenna and the Rx synchronization antenna.

Example 24 includes the subject matter of Example 15-23, and optionally, wherein the synchronization detector is configured to determine the synchronization information to synchronize the second radar front-end to the first radar front-end.

Example 25 includes the subject matter of any one of Examples 15-24, and optionally, comprising a processor configured to process the Rx radar data based on the synchronization information to determine radar information of a Multiple-Input-Multiple-Output (MIMO) radar antenna comprising a convolution of the plurality of Rx antennas and the plurality of Tx antennas.

Example 26 includes the subject matter of any one of Examples 15-25, and optionally, wherein the second radar front-end comprises an other plurality of Tx antennas configured to transmit an other Tx radar signal towards the target detection direction, wherein the first radar front-end comprises an other plurality of Rx antennas configured to receive an other Rx radar signal based on the other Tx radar signal, and wherein the first radar front-end is configured to provide other Rx radar data based on the other Rx radar signal.

Example 27 includes the subject matter of Example 26, and optionally, comprising a processor configured to process the Rx radar data and the other Rx radar data based on the synchronization information to determine radar information of a Multiple-Input-Multiple-Output (MIMO) radar antenna comprising a convolution of MIMO Rx antennas and MIMO Tx antennas, the MIMO Tx antennas comprising the plurality of Tx antennas of the first radar front-end and the plurality of Tx antennas of the second radar front-end, the MIMO Rx antennas comprising the plurality of Rx antennas of the first radar front-end and the plurality of Rx antennas of the second radar front-end.

Example 28 includes the subject matter of any one of Examples 15-27, and optionally, wherein the Tx radar signal comprises a chirp signal.

Example 29 includes the subject matter of any one of Examples 15-28, and optionally, comprising a vehicle, the vehicle comprising a processor configured to generate radar information based on the Rx radar data, and a system controller to control one or more systems of the vehicle based on the radar information.

Example 30 includes an apparatus comprising a transmitter to transmit (Tx) a sequence of radar frames via a Tx antenna wherein the transmitter is configured to transmit a radar frame by transmitting a non-periodic Tx radar signal having a non-periodic pattern within the radar frame; a receiver to receive (Rx) a radar Rx signal via at least one Rx antenna, and to generate a digital Rx signal based on the radar Rx signal, wherein the radar Rx signal is based on the non-periodic Tx radar signal; and a processor to generate radar information based on the digital Rx signal, the processor configured to generate the non-periodic Tx radar signal by applying a reference code to a periodic Tx radar signal having a periodic pattern, and to process the digital Rx signal based on the periodic Tx radar signal and the reference code.

In one example, the apparatus of Example 30 may include, for example, one or more additional elements, and/or may perform one or more additional operations and/or functionalities, for example, as described with respect to Examples 1, 15, 45 and/or 54.

Example 31 includes the subject matter of Example 30, and optionally, wherein the processor is configured to transform the digital Rx signal into a frequency-domain radar Rx signal in a frequency-domain, to determine cross-correlation (XCORR) data corresponding to a plurality of Doppler values by multiplying the frequency-domain radar Rx signal by a plurality of coded reference signals corresponding to the plurality of Doppler values, respectively, and to generate range-Doppler data by transforming the XCORR data to a time-domain, wherein a coded reference signal corresponding to a Doppler value is based on the reference code, the periodic Tx signal and the Doppler value.

Example 32 includes the subject matter of Example 31, and optionally, wherein the processor comprises a plurality of digital matched filters to multiply the frequency-domain radar Rx signal by the plurality of coded reference signals, respectively, a digital matched filter corresponding to the Doppler value to generate XCORR data corresponding to the Doppler value by multiplying the frequency-domain radar Rx signal by the coded reference signal corresponding to the Doppler value.

Example 33 includes the subject matter of Example 31 or 32, and optionally, wherein the processor is configured to decimate the XCORR data into decimated XCORR data, and to generate the range-Doppler data by transforming the decimated XCORR data into the time-domain.

Example 34 includes the subject matter of Example 33, and optionally, wherein the processor is configured to decimate the XCORR data according to a decimation factor of at least 50.

Example 35 includes the subject matter of Example 33, and optionally, wherein the processor is configured to decimate the XCORR data according to a decimation factor of at least 100.

Example 36 includes the subject matter of Example 33, and optionally, wherein the processor is configured to decimate the XCORR data according to a decimation factor of at least 200.

Example 37 includes the subject matter of Example 33, and optionally, wherein the processor is configured to decimate the XCORR data according to a decimation factor of at least 500.

Example 38 includes the subject matter of any one of Examples 33-37, and optionally, wherein the processor is configured to transform the digital Rx signal into the frequency-domain Rx signal by applying a Fast Fourier Transform (FFT) to the digital Rx signal, and to transform the decimated XCORR data into the time domain by applying an Inverse FFT (IFFT) to the decimated XCORR data.

Example 39 includes the subject matter of Example 38, and optionally, wherein a ratio between an FFT size of the FFT and an IFFT size of the IFFT is based on a decimation factor of the decimated XCORR data relative to the XCORR data.

Example 40 includes the subject matter of any one of Examples 30-39, and optionally, wherein the reference code comprises a random reference code.

Example 41 includes the subject matter of any one of Examples 30-40, and optionally, wherein the processor is configured to generate the non-periodic Tx radar signal by multiplying the reference code by the periodic Tx radar signal.

Example 42 includes the subject matter of any one of Examples 30-41, and optionally, comprising a Multiple-Input-Multiple-Output (MIMO) radar antenna comprising the Tx antenna and the Rx antenna.

Example 43 includes the subject matter of any one of Examples 30-42, and optionally, comprising the Tx antenna, the Rx antenna, and an Rx chain to generate the digital Rx signal.

Example 44 includes the subject matter of Example 43, and optionally, comprising a vehicle, the vehicle comprising a system controller to control one or more systems of the vehicle based on the radar information.

Example 45 includes an apparatus comprising a transmitter to transmit (Tx) a plurality of radar frames via plurality of Tx antennas, wherein the transmitter is configured to transmit the plurality of radar frames by transmitting a plurality of Tx radar signals via the plurality of Tx antennas according to a non-periodic mapping scheme comprising a non-periodic sequence of mappings, the transmitter to transmit a radar frame of the plurality of radar frames by transmitting the plurality of Tx radar signals via the plurality of Tx antennas according to a mapping of the non-periodic sequence of mappings; a receiver to receive (Rx) a plurality of radar Rx signals via plurality of Rx antennas, the radar Rx signals based on the plurality of Tx radar signals; and a processor to generate radar information based on the radar Rx signals, wherein the processor is to configure the transmitter to transmit the plurality of Tx radar signals via the plurality of Tx antennas according to the non-periodic mapping scheme, and to process the plurality of radar Rx signals based on the non-periodic mapping scheme.

In one example, the apparatus of Example 45 may include, for example, one or more additional elements, and/or may perform one or more additional operations and/or functionalities, for example, as described with respect to Examples 1, 15, 30 and/or 54.

Example 46 includes the subject matter of Example 45, and optionally, wherein the processor is to configure the transmitter to transmit a first radar frame by mapping the plurality of Tx radar signals to the plurality of Tx antennas according to a first mapping of the non-periodic sequence of mappings, and to transmit a second radar frame by mapping the plurality of Tx radar signals to the plurality of Tx antennas according to a second mapping of the non-periodic sequence of mappings, wherein the second mapping of the non-periodic sequence of mappings is different from the first mapping of the non-periodic sequence of mappings.

Example 47 includes the subject matter of Example 45 or 46, and optionally, wherein non-periodic sequence of mappings comprises a random sequence of mappings.

Example 48 includes the subject matter of any one of Examples 45-47, and optionally, wherein the plurality of Tx radar signals comprises a plurality of periodic Tx radar signals, a periodic Tx radar signal having a periodic pattern within the radar frame.

Example 49 includes the subject matter of any one of Examples 45-48, and optionally, wherein the plurality of Tx radar signals comprises a plurality of non-periodic Tx radar signals having a non-periodic pattern within the radar frame.

Example 50 includes the subject matter of any one of Examples 45-49, and optionally, wherein the plurality of Tx radar signals comprises a plurality of chirp signals.

Example 51 includes the subject matter of any one of Examples 45-50, and optionally, comprising a Multiple-Input-Multiple-Output (MIMO) radar antenna comprising the Tx antennas and the Rx antennas.

Example 52 includes the subject matter of any one of Examples 45-51, and optionally, comprising the Tx antennas, the Rx antennas, and a plurality of Rx chains to process the plurality of radar Rx signals.

Example 53 includes the subject matter of Example 52, and optionally, comprising a vehicle, the vehicle comprising a system controller to control one or more systems of the vehicle based on the radar information.

Example 54 includes an apparatus comprising a radome configured to cover a radar antenna; a polymeric conductive layer bonded to the radome, the polymeric conductive layer configured to heat the radome when the polymeric conductive layer is subject to an electrical current; and a plurality of electrical contacts to electrically connect the polymeric conductive layer to a current supply to drive the electrical current via the polymeric conductive layer.

In one example, the apparatus of Example 54 may include, for example, one or more additional elements, and/or may perform one or more additional operations and/or functionalities, for example, as described with respect to Examples 1, 15, 30 and/or 45.

Example 55 includes the subject matter of Example 54, and optionally, wherein the polymeric conductive layer is bonded to a backside of the radome facing the radar antenna.

Example 56 includes the subject matter of Example 54 or 55, and optionally, wherein the polymeric conductive layer is between the radome and the radar antenna.

Example 57 includes the subject matter of any one of Examples 54-56, and optionally, wherein the polymeric conductive layer covers a region of the radome covering the radar antenna.

Example 58 includes the subject matter of any one of Examples 54-57, and optionally, wherein the polymeric conductive layer comprises a carbon-based filler.

Example 59 includes the subject matter of Example 58, and optionally, wherein the carbon-based filler comprises at least one of carbon fibers, a Carbon Nanotube (CNT), graphite, or black carbon.

Example 60 includes the subject matter of any one of Examples 54-59, and optionally, wherein the polymeric conductive layer comprises a printed conductive ink layer.

Example 61 includes the subject matter of any one of Examples 54-60, and optionally, comprising a diffusion-bonding layer bonding the polymeric conductive layer to the radome.

Example 62 includes the subject matter of any one of Examples 54-60, and optionally, wherein the polymeric conductive layer comprises an overmolded polymeric conductive layer.

Example 63 includes the subject matter of any one of Examples 54-60, and optionally, wherein the polymeric conductive layer comprises an injected molded polymeric conductive layer.

Example 64 includes the subject matter of any one of Examples 54-63, and optionally, wherein the plurality of electrical contacts comprises a plurality of Three-Dimensional Molded Interconnect Devices (3D-MID) electrical contacts.

Example 65 includes the subject matter of any one of Examples 54-64, and optionally, wherein the plurality of electrical contacts comprises a plurality of conductive adhesive contacts.

Example 66 includes the subject matter of any one of Examples 54-65, and optionally, wherein the plurality of electrical contacts comprises a plurality of Two-Dimensional (2D) electrical contacts.

Example 67 includes the subject matter of any one of Examples 54-66, and optionally, comprising a temperature sensor configured to sense a temperature of the radome, and a controller configured to control the current supply to drive the current via the polymeric conductive layer based on the temperature of the radome.

Example 68 includes the subject matter of Example 67, and optionally, wherein the controller is configured to detect a malfunction event and to generate a malfunction indication signal, the controller configured to detect the malfunction event based on at least one of the current via the polymeric conductive layer, the temperature of the radome, and/or radar information generated based on radar signals received via the radar antenna.

Example 69 includes the subject matter of any one of Examples 54-68, and optionally, comprising a processor to generate radar information based on radar signals received via the radar antenna, the processor configured to detect a malfunction event of the radome and to generate a malfunction indication signal, the processor configured to detect the malfunction event of the radome based on the radar signals received via the radar antenna.

Example 70 includes the subject matter of any one of Examples 54-69, and optionally, comprising the radar antenna, and a processor to generate radar information based on radar signals received via the radar antenna.

Example 71 includes the subject matter of Example 70, and optionally, comprising a vehicle, the vehicle comprising a system controller to control one or more systems of the vehicle based on the radar information.

Example 72 includes a radar device comprising one or more of the apparatuses of Examples 1-71.

Example 73 includes a vehicle comprising one or more of the apparatuses of Examples 1-71.

Example 74 includes an apparatus comprising means for executing any of the described operations of Examples 1-71.

Example 75 includes a machine-readable medium that stores instructions for execution by a processor to perform any of the described operations of Examples 1-71.

Example 76 includes an apparatus comprising a memory; and processing circuitry configured to perform any of the described operations of Examples 1-71.

Example 77 includes a method including any of the described operations of Examples 1-71.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-17. (canceled)

18. An apparatus comprising:
a processor configured to:
determine radar synchronization information to synchronize between a first radar and a second radar, wherein the first radar is to communicate radar signals in a first radar Field Of View (FOV), and the second radar is to communicate radar signals in a second radar FOV, wherein the first and second radar FOVs partially overlap; and
generate radar information corresponding to a target based on the radar synchronization information, a Transmit (Tx) radar signal transmitted by the first radar, a first Receive (Rx) signal received by the first radar based on the Tx radar signal, and a second Rx signal received by the second radar based on the Tx radar signal; and
a memory to store information processed by the processor.

19. The apparatus of claim 18, wherein the processor is configured to:
determine a plurality of Radar Cross Section (RCS) estimations, the plurality of RCS estimations comprising a first RCS estimation and a second RCS estimation, wherein the first RCS estimation is based on the Tx radar signal transmitted by the first radar and the first Rx signal received by the first radar based on the Tx radar signal, wherein the second RCS estimation is based on the Tx radar signal transmitted by the first radar and the second Rx signal received by the second radar based on the Tx radar signal; and
determine the radar information corresponding to the target based on the plurality of RCS estimations.

20. The apparatus of claim 19, wherein the plurality of RCS estimations comprises a third RCS estimation and a fourth RCS estimation, wherein the third RCS estimation is based on an other Tx radar signal transmitted by the second radar and a third Rx signal received by the second radar based on the other Tx radar signal, wherein the fourth RCS estimation is based on the other Tx radar signal transmitted by the second radar and a fourth Rx signal received by the first radar based on the other Tx radar signal.

21. The apparatus of claim 18, wherein the processor is configured to determine the radar information corresponding to the target by applying a super-resolution algorithm to a first snapshot and a second snapshot, wherein the first snapshot is based on the Tx radar signal transmitted by the first radar and the first Rx signal received by the first radar based on the Tx radar signal, wherein the second snapshot is based on the Tx radar signal transmitted by the first radar and the second Rx signal received by the second radar based on the Tx radar signal.

22. The apparatus of claim 18, wherein the processor is configured to identify a ghost target in a multipath scenario based on the second Rx signal received by the second radar, and to generate the radar information based on identification of the ghost target.

23. The apparatus of claim 22, wherein the processor is configured to identify the ghost target based on detection of an appearance of the ghost target in a first radar path and detection of disappearance of the ghost target in a second radar path, wherein the first radar path comprises the Tx radar signal from the first radar and the second Rx signal received by the second radar based on the Tx radar signal from the first radar, wherein the second radar path comprises an other Tx radar signal from the second radar and an other Rx signal received by the first radar based on the other Tx radar signal from the second radar.

24. The apparatus of claim 22, wherein the processor is configured to identify the ghost target based on detection of an appearance of the ghost target in a first radar path and detection of disappearance of the ghost target in a second radar path, wherein the first radar path comprises a first Tx radar signal from the first radar to a first target, a first scattered signal from the first target, a first reflected signal reflected from a second target back to the first target, and a second reflected signal reflected back from the first target to the first radar, wherein the second radar path comprises a second Tx radar signal from the second radar to the second target, a second scattered signal from the second target, a third reflected signal reflected from the first target back to the second target, and a fourth reflected signal reflected back from the second target to the second radar.

25. The apparatus of claim 18, wherein the processor is configured to determine the radar synchronization information based on timing information broadcasted by the first radar and received by the second radar.

26. The apparatus of claim 18, wherein the processor is configured to determine the radar information corresponding to the target based on shared radar information broadcasted by the first radar and received by the second radar.

27. The apparatus of claim 18, wherein the processor is configured to determine the radar synchronization information to synchronize between the first and second radars at an accuracy of up to 1 nanosecond.

28. A system comprising:
a first radar comprising a first plurality of Transmit (Tx) antennas and a first plurality of Receive (Rx) antennas, the first radar configured to communicate radar signals in a first radar Field Of View (FOV);
a second radar comprising a second plurality of Tx antennas and a second plurality of Rx antennas, the second radar configured to communicate radar signals in a second radar FOV, wherein the first and second radar FOVs partially overlap; and
a processor configured to:
determine radar synchronization information to synchronize between the first radar and the second radar; and
generate radar information corresponding to a target based on the radar synchronization information, a Tx radar signal transmitted by the first radar, a first Rx signal received by the first radar based on the Tx radar signal, and a second Rx signal received by the second radar based on the Tx radar signal.

29. The system of claim 28, wherein the processor is configured to:
determine a plurality of Radar Cross Section (RCS) estimations, the plurality of RCS estimations comprising a first RCS estimation and a second RCS estimation, wherein the first RCS estimation is based on the Tx radar signal transmitted by the first radar and the first Rx signal received by the first radar based on the Tx radar signal, wherein the second RCS estimation is based on the Tx radar signal transmitted by the first radar and the second Rx signal received by the second radar based on the Tx radar signal; and
determine the radar information corresponding to the target based on the plurality of RCS estimations.

30. The system of claim 28, wherein the processor is configured to determine the radar information corresponding to the target by applying a super-resolution algorithm to a first snapshot and a second snapshot, wherein the first snapshot is based on the Tx radar signal transmitted by the first radar and the first Rx signal received by the first radar based on the Tx radar signal, wherein the second snapshot is based on the Tx radar signal transmitted by the first radar and the second Rx signal received by the second radar based on the Tx radar signal.

31. The system of claim 28, wherein the processor is configured to identify a ghost target in a multipath scenario based on the second Rx signal received by the second radar, and to generate the radar information based on identification of the ghost target.

32. The system of claim 28 comprising a vehicle, the vehicle comprising a system controller configured to control one or more systems of the vehicle based on the radar information.

33. The system of claim 28 comprising a plurality of radars comprising the first radar and the second radar, the plurality of radars configured to cover a respective plurality of FOVs, wherein a combination of the plurality of FOVs covers a FOV of substantially 360 degrees.

34. A product comprising one or more tangible computer-readable non-transitory storage media comprising instructions operable to, when executed by at least one processor, cause the at least one processor to:
determine radar synchronization information to synchronize between a first radar and a second radar, wherein the first radar is to communicate radar signals in a first radar Field Of View (FOV), and the second radar is to communicate radar signals in a second radar FOV, wherein the first and second radar FOVs partially overlap; and
generate radar information corresponding to a target based on the radar synchronization information, a Transmit (Tx) radar signal transmitted by the first radar, a first Receive (Rx) signal received by the first radar based on the Tx radar signal, and a second Rx signal received by the second radar based on the Tx radar signal.

35. The product of claim 34, wherein the instructions, when executed, cause the at least one processor to:
determine a plurality of Radar Cross Section (RCS) estimations, the plurality of RCS estimations comprising a first RCS estimation and a second RCS estimation, wherein the first RCS estimation is based on the Tx radar signal transmitted by the first radar and the first Rx signal received by the first radar based on the Tx radar signal, wherein the second RCS estimation is based on the Tx radar signal transmitted by the first radar and the second Rx signal received by the second radar based on the Tx radar signal; and
determine the radar information corresponding to the target based on the plurality of RCS estimations.

36. The product of claim 34, wherein the instructions, when executed, cause the at least one processor to determine the radar information corresponding to the target by applying a super-resolution algorithm to a first snapshot and a second snapshot, wherein the first snapshot is based on the Tx radar signal transmitted by the first radar and the first Rx signal received by the first radar based on the Tx radar signal, wherein the second snapshot is based on the Tx radar signal transmitted by the first radar and the second Rx signal received by the second radar based on the Tx radar signal.

37. The product of claim 34, wherein the instructions, when executed, cause the at least one processor to identify a ghost target in a multipath scenario based on the second Rx signal received by the second radar, and generating the radar information based on identification of the ghost target.
